(19) United States
(12) Patent Application Publication
(10) Pub. No.: US 2011/0138266 A1
(43) Pub. Date: Jun. 9, 2011

(54) DOCUMENT PROCESSING AND MANAGEMENT APPROACH FOR CREATING A TAG OR AN ATTRIBUTE IN A MARKUP LANGUAGE DOCUMENT, AND METHOD THEREOF

(75) Inventors: Masayuki Hiyama, Tokyo (JP); Nobuaki Wake, Tokushima (JP)

(73) Assignee: Clairvoyance Corporation, Pittsburgh, PA (US)

(21) Appl. No.: 11/659,021

(22) PCT Filed: Aug. 2, 2005
(86) PCT No.: PCT/US05/27402

§ 371 Date: Mar. 30, 2009

Related U.S. Application Data
(60) Provisional application No. 60/592,369, filed on Aug. 2, 2004.

(51) Int. Cl. G06F 17/00

(52) U.S. Cl. 715/234

(57) ABSTRACT

A method of creating a tag or an attribute in a markup language document, the method including receiving information in an editable area of an interface and creating the tag or the attribute based on the received information.

This Application claims priority from co-pending U.S. Provisional Application No. 60/592,369 filed Aug. 2, 2004, titled “A Document Processing and Management System,” the disclosure of which is incorporated herein by reference.

### BACKGROUND OF THE INVENTION

1. Field of the Invention

The present invention relates to a system, method, and interface for creating a tag or an attribute in a markup language document. The markup language can be, for example, extensible markup language (XML).

2. Description of the Related Art

### Synopsis

The advent of the Internet has resulted in a near exponential increase in the number of documents processed and managed by users. The World Wide Web (also known as the Web), which forms the core of the Internet, includes a large data repository of such documents. In addition, to the documents, the Web provides information retrieval systems for such documents. These documents are often formatted in markup languages, a simple and popular one being Hypertext Markup Language (HTML). Such documents also include links to other documents, possibly located in other parts of the Web. An Extensible Markup Language (XML) is another more advanced and popular markup language. Simple browsers for accessing and viewing the documents Web are developed in (object-oriented) programming languages such as Java.

Documents formatted in markup languages are typically represented in browsers and other applications in the form of a tree data structure. Such a representation corresponds to a parse tree of the document. The Document Object Model (DOM) is a well-known tree-based data structure model used for representing and manipulating documents. The Document Object Model provides a standard set of objects for representing documents, including HTML and XML documents. The DOM includes two basic components, a standard model of how the objects that represent components in the documents can be combined, and a standard interface for accessing and manipulating them.

Application developers can support the DOM as an interface to their own specific data structures and application program interfaces (APIs). On the other hand, application developers creating documents can use standard DOM interfaces rather than interfaces specific to their own APIs. Thus, based on its ability to provide a standard, the DOM is effective to increase the interoperability of documents in various environments, particularly on the Web. Several variation of the DOM have been defined and are used by different programming environments and applications.

A DOM tree is a hierarchical representation of a document based on the contents of the corresponding DOM. The DOM tree includes a “root,” and one or more “nodes” arising from the root. In some cases, the root represents the entire document. Intermediate nodes could represent elements such as a table and the rows and columns in that table, for example. The “leaves” of the DOM tree usually represent data, such as text items or images that are not further decomposable. Each node in the DOM tree can be associated with attributes that describe parameters of the element represented by the node, such as font, size, color, indentation, etc.

HTML, while being a commonly used language for creating documents, is a formatting and layout language. HTML is not a data description language. The nodes of a DOM tree that represents an HTML document are predefined elements that correspond to HTML formatting tags. Since HTML normally does not provide any data description or any tagging/labeling of data, it is often difficult to formulate queries for data in an HTML document.

A goal of network designers is to allow Web documents to be queried or processed by software applications. Hierarchically organized languages that are display-independent can be queried and processed in such a manner. Markup languages, such as XML (eXtensible Markup Language), can provide these features.

As opposed to HTML, a well known advantage of XML is that it allows a designer of a document to label data elements using freely definable “tags.” Such data elements can be organized hierarchically. In addition, an XML document can contain a Document Type Definition (DTD), which is a description of the “grammar” (the tags and their interrelationship) used in the document. In order to define display methods of structured XML documents, CSS (Cascading Style Sheets) or XSL (XML style Language) are used. Additional information concerning DOM, HTML, XML, CSS, XSL and related language features can be also obtained from the Web, for example, at http://www.w3.org/TR/.

XPath provides common syntax and semantics for addressing parts of an XML document. An example of the functionality is the traversing of a DOM tree corresponding to an XML document. It provides basic facilities for manipulation of strings, numbers and Booleans characters that are associated with the various representations of the XML document. XPath operates on the abstract, logical structure of an XML document, for example the DOM tree, rather than its surface syntax. Such a surface syntax could, for example, include line or character positions in sequence. Using XPath one can navigate through the hierarchical structure, for example, in a DOM tree of an XML document. In addition to its use for addressing, XPath is also designed to be used for testing whether or not a node in a DOM tree matches a pattern.

Additional details regarding XPath can be found in http://www.w3.org/TR/XPath.

Given the advantages and features already known for XML, there is a need for an effective document processing and management systems that can handle documents in a markup language, for example XML, and provide a user friendly interface for creating and modifying the documents.

Extensive Markup Language (XML) is particularly suited as a format for complex documents or for cases where data related to a document is used in common with data for other documents via a network and the like. Many applications for creating, displaying and editing the XML documents have been developed (see, for example, Japanese Patent Application Laid Open No. 2001-290804).

The vocabulary may be defined arbitrarily. In theory, therefore, there may exist an infinite number of vocabularies. However, it does not serve any practical purpose to provide display/edit environments for exclusive-use with these vocabularies individually. In the related art, in a case of a document described in a vocabulary that is not provided with a dedicated edit environment, the source of a document composed of text data is directly edited using a text editor and the like.

Existing applications that process and manage XML documents have significant limitations that prevent their wider acceptance. For example, in some related art XML document processing systems, characteristics of XML documents that express the content that are not relevant to the method of its display can be viewed. While this feature may be viewed superficially as an advantage, it is actually disadvantageous in that the user may not edit it directly. To solve this problem, some related art XML document processing systems specifically design screens for receiving XML input. However, the flexibility of such a screen design is limited. This is because the screen design on such XML document processing systems must be hard coded beforehand.

In view of this limitation, XSLT was developed as one of the standards for Style Sheet languages. Such a technology can free a user from hard coding, and is compatible with the applicable methods of displaying XML documents. However, using XSLT one cannot edit an XML document using only the displayed version of the document.

Moreover, such related art XML processing systems rely on the placement of “Schema.” Therefore, once the scheme is decided, only the XML document that corresponds to the schema structure from a top level can be handled by the processing systems. In other words, such systems are overly restrictive and rigid.

In the disclosed systems, the foregoing restrictions are not present. The structure of the entire XML document need not be rigidly decided. The compound XML document with various structures can be safely treated by dividing the XML document into smaller parts. The smaller parts are individually dispatched to an edit module achieving greater flexibility. In addition, the edit modules could be preferably represented by plug-ins. Further, a flexible screen design can be implemented by the user without any need for hard coding. In short, WYSIWYG editing can be achieved.

Some of the components of the system described herein are described using a well known graphical user interface (GUI) paradigm called Model-View-Controller (MVC). The MVC paradigm offers a way of breaking an application, or even just a piece of an application's interface, into three parts: the model, the view, and the controller. MVC was originally developed to map the traditional input, processing, output roles into the GUI realm.

Input→Processing→Output

Controller→Model→View

According to the MVC paradigm, the user input, the modeling of the external world, and the visual feedback to the user are separated and handled by model (M), viewport (V) and controller (C) objects. The controller is operative to interpret inputs, such as mouse and keyboard inputs from the user, and map these user actions into commands that are sent to the model and/or viewport to effect an appropriate change. The model is operative to manage one or more data elements, responds to queries about its state, and responds to instructions to change state. The viewport is operative to manage a rectangular area of a display, and is responsible for presenting data to the user through a combination of graphics and text.

In inputting a required element in XML, the conventional way is to create an element without any text, and add text to it. This method has a negative side-effect when the user saves the document, as this empty element will also be output to file. In the conventional art, an element is pre-created regardless of whether a user is going to enter text into a text field corresponding to the element. Thus, a text field corresponding to an element is sometimes unnecessarily created and a pre-created element takes up space in memory.

### SUMMARY OF THE INVENTION

To realize some of the desirable objects of the present invention, the following aspects of the present invention are provided.

The present invention provides, according to an exemplary embodiment, a method of creating a tag or an attribute in a markup language document, the method including receiving information in an editable area of an interface and creating the tag or the attribute based on the received information.

Also, according to an exemplary embodiment, the present invention provides a system for editing, by a user, a markup language document, the system including a display unit having an editable area and a conversion unit which adds a tag or an attribute to the markup language document based on whether said editable area is edited.

Yet further, according to an exemplary embodiment, the present invention provides an interface based on a markup language, including an editable area, wherein said editable area determines whether one of a tag and an attribute is created.

Yet even further, according to an exemplary embodiment, the present invention provides a user interface based on an extensible markup language (XML), the user interface including an editable area, wherein the editable area determines whether a tag or an attribute is created in a source document.

Moreover, according to an exemplary embodiment, the present invention provides a method of creating, using a markup language, an environment used to create a tag or an attribute, the method including creating, using said markup language, an interface including an editable area, said interface being part of the created environment, wherein the editable area determines whether the tag or said attribute is created.

Finally, other aspects of the disclosed teachings include a computer program product including computer readable media that comprise instructions to enable a computer to implement the techniques described in this disclosure.

### BRIEF DESCRIPTION OF THE DRAWINGS

Embodiments of the invention are described below in detail with reference to the following drawings in which like reference numerals refer to like elements wherein:

FIG. 1(a) illustrates a conventional arrangement of components that can serve as the basis of an exemplary implementation of the disclosed document processing and management system.

FIGS. 1(b) and 1(c) show an overall block diagram of an exemplary document processing and management system.

FIG. 2 shows further details of an exemplary implementation of the document manager.

FIG. 3 shows further details of an exemplary implementation of the vocabulary connection subsystem 300.

FIG. 4(a) shows further details of an exemplary implementation of the program invoker and its relation with other components.

FIG. 4(b) shows further details of an exemplary implementation of the service broker and its relation to other components.

FIG. 4(c) shows further details of an exemplary implementation of services.

FIG. 4(d) shows examples of services.

FIG. 4(e) shows further details on the relationships between the program invoker 103 and the user application 106.

FIG. 5(a) provides further details on the structure of an application service loaded onto the program invoker.

FIG. 5(b) shows an example of the relationships between a frame, a menu bar and a status bar.

FIG. 6(a) shows further details related to an exemplary implementation of the application core.

FIG. 6(b) shows further details related to an exemplary implementation of snap shot.

FIG. 7(a) shows further details related to an exemplary implementation of the document manager.

FIG. 7(b) shows an example of how a set of documents A-E are arranged in a hierarchy.

FIG. 7(c) shows an example of how the hierarchy of documents shown in FIG. 7(b) appears on a screen.

FIGS. 8(a) and 8(b) provide further details of an exemplary implementation of the undo framework and undo command.

FIG. 9(a) shows an overview of how a document is loaded in the document processing and management system shown in FIGS. 1(b) and 1(c).

FIG. 9(b) shows a summary of the structure for the zone, using the MVC paradigm.

FIG. 10 shows an example of a document and its various representations in accordance with the present invention.

FIG. 11(a) shows a simplified view of the MV relationship for the XHTM component of the document shown in FIG. 10.

FIG. 11(b) shows a vocabulary connection for the document shown in FIG. 11(a).

FIGS. 12(a)-12(c) shows further details related to exemplary implementations of the plug-in sub-system, vocabulary connections and connector, respectively.

FIG. 13 shows an example of a VCD script using vocabulary connection manager and the connector factory tree for a file MySampleXML.

FIGS. 14(a)-(c) shows steps 0-3 of loading the example document MySampleXML into the exemplary document processing and management system of FIG. 1(b).

FIG. 15 shows step 4 of loading the example document MySampleXML into the exemplary document processing and management system of FIG. 1(b).

FIG. 16 shows step 5 of loading the example document MySampleXML into the exemplary document processing and management system of FIG. 1(b).

FIG. 17(a) shows step 6 of loading the example document MySampleXML into the exemplary document processing and management system of FIG. 1(b).

FIG. 17(b) shows step 7 of loading the example document MySampleXML into the exemplary document processing and management system of FIG. 1(b).

FIG. 18(a) shows a flow of an event that has occurred on a node that does not have a corresponding source node and dependent on a destination tree alone.

FIG. 18(b) shows a flow of an event which has occurred on a node of a destination tree which is associated with a source node by TextOfConnector.

FIG. 19 shows a screenshot showing editable fallback section and corresponding xml.

FIG. 20 shows a screenshot illustrating the process of entering character(s);

FIG. 21 shows yet another screenshot.

FIG. 22 shows a screenshot showing a process of moving from a fallback section to the next editable field.

FIG. 23 shows the steps of an exemplary embodiment of the process of creating a tag or attribute, according to the present invention.

FIG. 24 shows the steps of yet another exemplary embodiment of the process of creating a tag or attribute, according to the present invention.

### DETAILED DESCRIPTION OF EXEMPLARY EMBODIMENTS

The following describes in detail exemplary embodiments of the invention, with reference to the accompanying drawings.

The claims alone represent the metes and bounds of the invention. The discussed implementations, embodiments and advantages are merely exemplary and are not to be construed as limiting the present invention. The description of the present invention is intended to be illustrative, and is not intended to limit the scope of the claims. Many alternatives, modifications, and variations will be apparent to those skilled in the art.

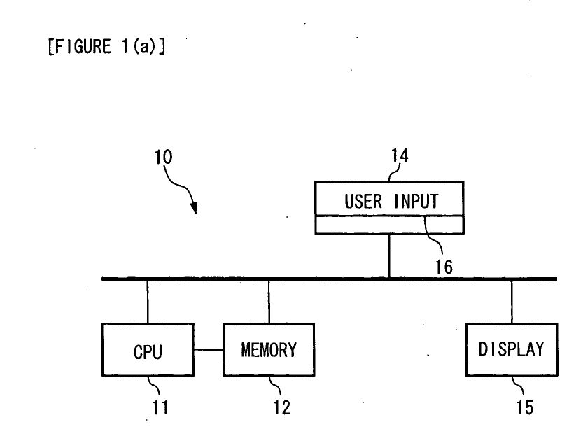

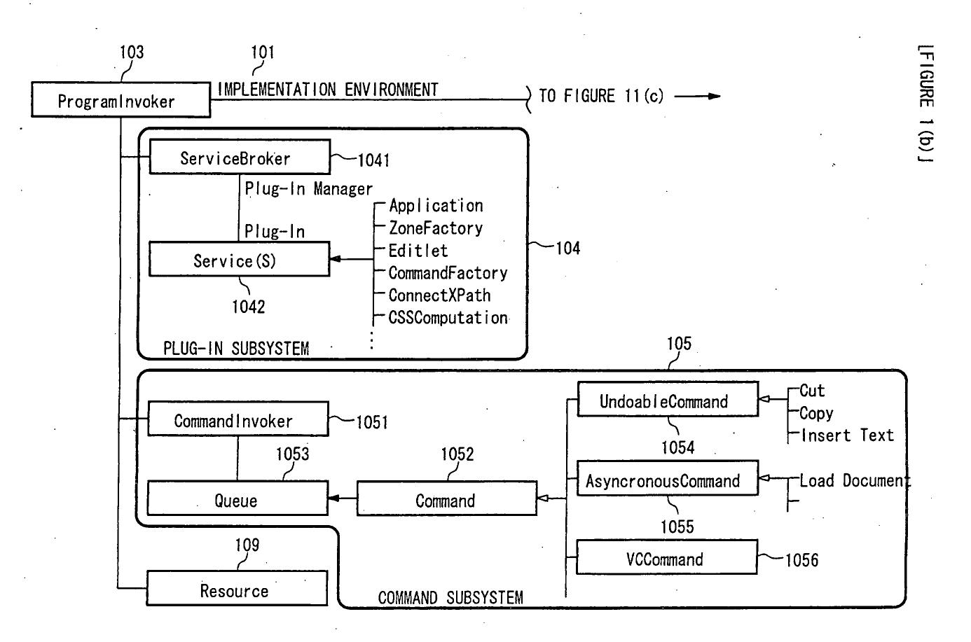

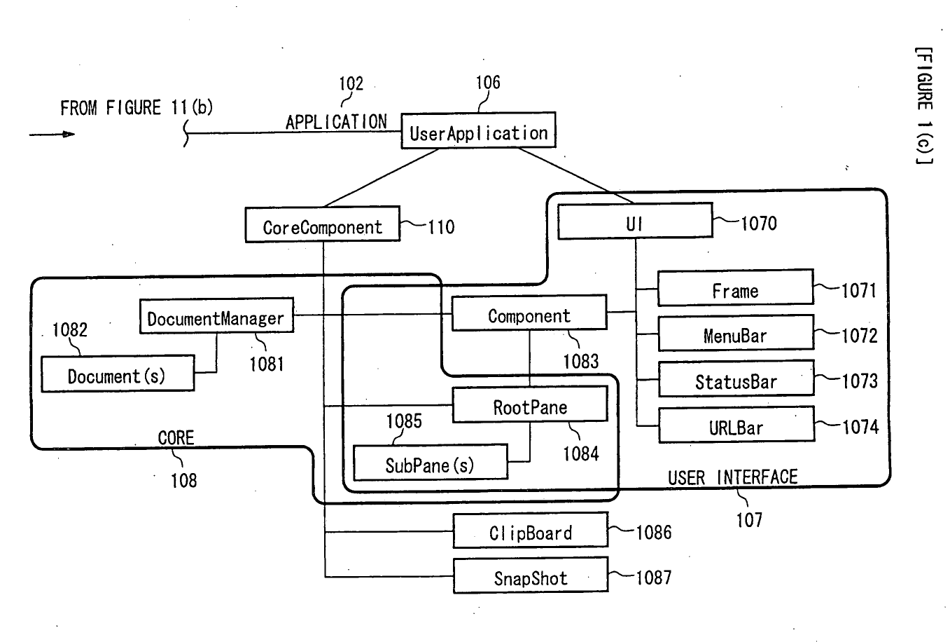

FIG. 1(a) illustrates a conventional arrangement of components that can serve as the basis of a document processing and management system, of the type subsequently detailed herein. The arrangement 10 includes a processor, in the form of a CPU or microprocessor 11 that is coupled to a memory 12, which may be any form of ROM and/or RAM storage available currently or in the future, by a communication path 13, typically implemented as a bus. Also coupled to the bus for communication with the processor 11 and memory 12 are an I/O interface 16 to a user input 14, such as a mouse, keyboard, voice recognition system or the like, and a display 15 (or other user interface). Other devices, such as a printer, communications modem and the like may be coupled into the arrangement, as would be well known in the art. The arrangement may be in a stand alone or networked form, coupling plural terminals and one or more servers together, or otherwise distributed in any one of a variety of manners known in the art. The invention is not limited by the arrangement of these components, their centralized or distributed architecture, or the manner in which various components communicate.

Further, it should be noted that the system and the exemplary implementations discussed herein are discussed as including several components and sub-components providing various functionalities. It should be noted that these components and sub-components could be implemented using hardware alone, software alone as well as a combination of hardware and software, to provide the noted functionalities. In addition, the hardware, software and the combination thereof could be implemented using general purpose computing machines or using special hardware or a combination thereof. Therefore, the structure of a component or the sub-component includes a general/special computing machine that runs the specific software in order to provide the functionality of the component or the sub-component.

FIG. 1(b) shows an overall block diagram of an exemplary document processing and management system. Documents are created and edited in such a document processing and management system. These documents could be represented in any language having characteristics of markup languages, such as XML. Also, for convenience, terminology and titles for the specific components and sub-components have been created. However, these should not be construed to limit the scope of the general teachings of this disclosure.

The document processing and management system can be viewed as having two basic components. One component is an “implementation environment” 101, that is the environment in which the processing and management system operates. For example, the implementation environment provides basic utilities and functionalities that assist the system as well as the user in processing and managing the documents. The other component is the “application component” 102, which is made up of the applications that run in the implementation environment. These applications include the documents themselves and their various representations.

Implementation Environment

A key component of the implementation environment 101 is a program invoker 103. The program invoker 103 is the basic program that is accessed to start the document processing and management system. For example, when a user logs on and initiates the document processing and management system, the program invoker 103 is executed. The program invoker 103, for example and without limitation, can read and process functions that are added as plug-ins to the document processing and management system, start and run applications, and read properties related to documents. When a user wishes to launch an application that is intended to be run in the implementation environment, the program invoker 103 finds that application, launches it and then executes the application. For example, when a user wishes to edit a document (which is an application in the implementation environment) that has already been loaded onto the system, the program invoker 103 first finds the document and then executes the necessary functions for loading and editing the document.

Program invoker 103 is attached to several components, such as a plug-in subsystem 104, a command subsystem 105 and a resource module 109. These components are described subsequently in greater detail.

Plug-In Subsystem

Plug-in subsystem 104 is used as a highly flexible and efficient facility to add functions to the document processing and management system. Plug-in subsystem 104 can also be used to modify or remove functions that exist in the document processing and management system. Moreover, a wide variety of functions can be added or modified using the plug-in subsystem. For example, it may be desired to add a function “editlet,” which is operative to help in rendering documents on the screen, as subsequently detailed. The plug-in editlet also helps in editing vocabularies that are added to the system.

The plug-in subsystem 104 includes a service broker 1041. The service broker 1041 manages the plug-ins that are added to the document processing and management system, thereby brokering the services that are added to the document processing and management system.

Individual functions representing functionalities that are desired are added to the system in the form of “services” 1042. The available types of services 1042 include, but are not limited to, an application service, a zone factory service, an editlet service, a command factory service, a connect XPath service, a CSS computation service, and the like. These services and their relationship to the rest of the system are described subsequently in detail, for a better understanding of the document processing and management system.

The relation between a plug-in and a service is that plug-in is a unit that can include one or more service providers, each service provider having one or more classes of services associated with it. For example, using a single plug-in that has appropriate software applications, one of more services can be added to the system, thereby adding the corresponding functionalities to the system.

Command Subsystem

The command subsystem 105 is used to execute instructions in the form of commands that are related to the processing of documents. A user can perform operations on the documents by executing a series of instructions. For example, the user processes an XML document, and edits the XML DOM tree corresponding to the XML document in the document management system, by issuing instructions in the form of commands. These commands could be input using keystrokes, mouse clicks, or other effective user interface actions. Sometimes, more than one instruction could be executed by a command. In such a case, these instructions are wrapped into a single command and are executed in succession. For example, a user may wish to replace an incorrect word with a correct word. In such a case, a first instruction may be to find the incorrect word in the document. A second instruction may be to delete the incorrect word. A third instruction may be to type in the correct word. These three instructions may be wrapped in a single command.

In some instances, the commands may have associated functions, for example, the “undo” function that is discussed later on in detail. These functions may in turn be allocated to some base classes that are used to create objects.

A component of the command subsystem 105 is the command invoker 1051, which is operative to selectively present and execute commands. While only one command invoker is shown in FIG. 1(b), more than one command invoker could be used and more than one command could be executed simultaneously. The command invoker 1051 maintains the functions and classes needed to execute the commands. In operation, commands 1052 that are to be executed are placed in a queue 1053. The command invoker creates a command thread that executes continuously. Commands 1052 that are intended to be executed by the command invoker 1051 are executed unless there is a command already executing in the command invoker. If a command invoker is already executing a command, a new command is placed at the end of the command queue 1053. However, for each command invoker 1051, only one command will be executed at a time. The command invoker 1051 executes a command exception if a specified command fails to be executed.

The types of commands that may be executed by the command invoker 1051 include, but are not limited to, undoable commands 1054, asynchronous commands 1055 and vocabulary connection commands 1056. Undoable commands 1054 are those commands whose effects can be reversed, if so desired by a user. Examples of undoable commands are cut, copy, insert text, etc. In operation, when a user highlights a portion of a document and applies a cut command to that portion, by using an undoable command, the cut portion can be “uncut” if necessary.

Vocabulary connection commands 1056 are located in the vocabulary connection descriptor script file. They are user-specified commands that can be defined by programmers. The commands could be a combination of more abstract commands, for example, for adding XML fragments, deleting XML fragments, setting an attribute, etc. These commands focus in particular on editing documents.

The asynchronous command 1055 is a command for loading or saving a document executed by the system and is executed asynchronously from the undoable command or VC command. The asynchronous command cannot be canceled, unlike the undoable command.

Asynchronous commands 1055 exist at a level below the vocabulary connection. They are commands more specific to the document processing and management system. Asynchronous commands are posted directly to the command invoker 1051. On the other hand, vocabulary connection commands 1056 are interpreted and converted to asynchronous commands and then posted onto the command invoker 1051.

Resource

Resource 109 are objects that provide some functions to various classes. For example, string resource, icons and default key binds are some of the resources used the system.

Application Component

The second main feature of the document processing system, the application component 102, runs in the implementation environment 101. Broadly, the application component 102 includes the actual documents including their various logical and physical representations within the system. It also includes the components of the system that are used to manage the documents. The application component 102 further includes the user application 106, application core 108, the user interface 107 and the core component 110.

User Application

A user application 106 is loaded onto the system along with the program invoker 103. The user application 106 is the glue that holds together, the documents, the various representations of the document and the user interface features that are needed to interact with a document. For example, a user may wish to create a set of documents that are part of a project. These documents are loaded, the appropriate representations for the documents are created, the user interface functionalities are added as part of the user application 106. In other words, the user application 106, holds together the various aspects of the documents and their representation that enable the user to interact with the documents that form part of the project. Once the user application 106 is created, the user can simply load the user application 106 onto the implementation environment, every time the user wishes to interact with the documents that form part of the project.

Core Component

The core component 110 provides a way of sharing documents among multiple panes. A pane, which is discussed subsequently in detail, represents a DOM tree and handles the physical layout of the screen. For example, a physical screen consists of various panes within the screen that describes individual pieces of information. In fact, the document which is viewed by a user on the screen could appear in one or more panes. In addition, two different documents could appear on the screen in two different panes.

The physical layout of the screen also is in the form of a tree, as illustrated in FIG. 1(c). Thus, where a component 1083 is to be on a screen as a pane, the pane could be implemented as a root-pane 1084. Alternately, it could be a sub-pane 1085. A root pane 1084 is the pane at the root of the tree of panes and a sub-pane 1085 is any pane other than the root pane 1084.

The core component 110 also provides fonts and acts as a source of plural functional operations, e.g., a toolkit, for the documents. One example of a task performed by the core component 110 is moving the mouse cursor among the various panes. Another example of a task performed is to mark a portion of a document in one, pane and copy it onto another pane containing a different document.

Application Core

As noted above, the application component 102 is made up of the documents that are processed and managed by the system. This includes various logical and physical representations for the document within the system. The application core 108 is a component of the application component 102. Its functionality is to hold the actual documents with all the data therein. The application core 108 includes the document manager 1081 and the documents 1082 themselves.

Various aspects of the document manager 1081 are described subsequently herein in further detail. Document manager manages documents 1082. The document manager is also connected to the root pane 1084, sub-pane 1085, a clip-board utility 1086 and a snapshot utility 1087. The clip-board utility 1086 provides a way of holding a portion of a document that a user decides to add to a clip-board. For example, a user may wish to cut a portion of the document and save it onto a new document for reviewing later on. In such a case, the cut portion is added to the clip-board.

The snapshot utility 1087 is also described subsequently, and enables a current state of the application to be memorized as the application moves from one state to another state.

User Interface

Another component of the application 102 is the user interface 107 that provides a means for the user to physically interact with the system. For example, the user interface, as implemented in physical interface 1070, is used to by the user to upload, delete, edit and manage documents. The user interface includes frame 1071, menu bar 1072, status bar 1073 and the URL bar 1074.

A frame, as is typically known, can be considered to be an active area of a physical screen. The menu bar 1072 is an area of the screen that includes a menu presenting choices for the user. The status bar 1073 is an area of the screen that displays the status of the execution of the application. The URL bar 1074 provides an area for entering a URL address for navigating the internet.

### Document Manager and the Associated Data Structures

FIG. 2 shows further details on the document manager 1081. This includes the data structures and components that are used to represent documents within the document processing and management system. For a better understanding, the components described in this subsection are described using the model view controller (MVC) representation paradigm.

The document manager 1081 includes a document container 203 that holds and hosts all of the documents that are in the document processing and management system. A toolkit 201, which is attached to the document manager 1081, provides various tools for the use by the document manager 1081. For example, “DOM service” is a tool provided by the toolkit 201 that provides all the functionalities needed to create, maintain and manage a DOM corresponding to a document. “IO manager,” which is another tool provided by the toolkit 201, manages the input and output, to and from the system, respectively. Likewise “stream handler” is a tool that handles the uploading of a document by means of a bit stream. These tools are not specifically illustrated or assigned reference numbers in the Figures, but form a component of the toolkit 201.

According to the MVC paradigm representation, the model (M) includes a DOM tree model 202 for a document. As discussed previously, all documents are represented within the document processing and management system as DOM trees. The document also forms part of the document container 203.

### DOM Model and Zone

DOM is a standard formed by W3C. It defines a standard interface for operating nodes. A specific operation within the standard is provided on a per-vocabulary or per-node basis. These operations are preferably provided as APIs. The document processing/management system provides such a node-specific API as a facet. Each facet is attached to a node. By attaching such a facet to the node, a useful API that conforms to the DOM standard is provided. By adding a specific API after the standard DOM has been implemented, as opposed to implementing a specific DOM for each vocabulary, it is possible to centrally process a variety of vocabularies. It is also possible to process a document that uses an arbitrary combination of vocabularies properly. Conventionally, a DOM may be represented schematically as a DOM tree.

The DOM tree that represents a document is a tree having nodes 2021. A zone 209, which is a subset of the DOM tree, includes one or more nodes of interest within the DOM tree. For example, only a part of a document could be presented on a screen. This part of the document that is visible could be represented using a “zone” 209. Zones are created, handled and processed using a plug-in called “zone factory” 205. While a zone represents a part of a DOM, it could use more than one “namespace.” As is well-known in the art, a namespace is a collection or a set of names that are unique within the namespace. In other words, no two names within the namespace can be the same.

Facet and Its Relationship with Zone

“Facet” 2022 is another component within the Model (M) part of the MVC paradigm. It is used to edit nodes in a zone. Facet 2022 organizes the access to a DOM, using procedures that can be executed without affecting the contents of the zone itself. As subsequently explained, these procedures perform meaningful and useful operations related to the nodes.

Each node 2021 has a corresponding facet 2022. By using facets to perform operations, instead of operating directly on the nodes in a DOM, the integrity of the DOM is preserved. Otherwise, if operations are performed directly on the node, several plug-ins could make changes to the DOM at the same time, causing inconsistency.

A “vocabulary” is a set of tags, for example XML tags, belonging to a namespace. As noted above, a namespace has a unique set of names (or tags in this specific case). A vocabulary appears as a subtree of a DOM tree representing an XML document. Such a sub-tree comprises a zone. In a specific example, boundaries of the tag sets are defined by zones. A zone 209 is created using service called a “zone factory service” 205. As described above, a zone 209 is an internal representation of a part of a DOM tree that represents a document. To provide access to such a part of the document, a logical representation is required. Such a logical representation informs the computer as to how the document is logically presented on a screen. “Canvas” 210 is a service that is operative to provide a logical layout corresponding to a zone.

A “pane,” such as pane 211, on the other hand, is the physical screen layout corresponding to the logical layout provided by the canvas 210. In effect, the user sees only a rendering of the document on a display screen in terms of characters and pictures. Therefore, the document must be rendered on the screen by a process for drawing characters and pictures on the screen. Based on the physical layout provided by the pane 211, the document is rendered on the screen by the canvas 210.

The canvas 210, which corresponds to the zone 209, is created using the “editlet service” 206. A DOM of a document is edited using the editlet service 206 and canvas 210. In order to maintain integrity of the original document, the editlet service 206 and the canvas service 210 use facets corresponding to the one or more nodes in the zone 209. These services do not manipulate nodes in the zone and the DOMs directly. The facet is manipulated using commands 207 from the (C)-component of the MVC paradigm, the controller.

A user typically interacts with the screen, for example, by moving cursor on the screen, and/or by typing commands. The canvas 2010, which provides the logical layout of the screen, receives these cursor manipulations. The canvas 2010 then enables corresponding action to be taken on the facets. Given this relationship, the cursor subsystem 204 serves as the Controller (C) of the MVC paradigm for the document manager 1081.

The canvas 2010 also has the task of handling events. For example, the canvas 2010 handles events such as mouse clicks, focus moves, and similar user initiated actions.

Summary of Relationships Between Zone, Facet, Canvas and Pane

A document within the document management and processing system can be viewed from at least four perspectives, namely: 1) data structure that is used to hold the contents and structure of the document in the document management system, 2) means to edit the contents of the document without affecting the integrity of the document; 3) a logical layout of the document on a screen; and, 4) a physical layout of the document on the screen. Zone, facet, canvas and pane represent components of the document management system that correspond to the above-mentioned four perspectives, respectively.

Undo Subsystem

As mentioned above, it is desirable that any changes to documents (for example, edits) should be undoable. For example, a user may perform an edit operation and then decide to undo such a change. With reference to FIG. 2, the undo subsystem 212 implements the undoable component of the document manager. An undo manager 2121 holds all of the operations on a document that have a possibility of being undone by the user. For example, a user may execute a command to replace a word in a document with another word. The user may then change his mind and decide to retain the original word. The undo subsystem 212 assists in such an operation. The undo manager 2121 holds such an undoable edit 2122 operation.

Cursor Subsystem

As previously noted, the controller part of the MVC can comprise the cursor subsystem 204. The cursor subsystem 204 receives inputs from the user. These inputs typically are in the nature of commands and/or edit operations. Therefore, the cursor subsystem 204 can be considered to be the controller (C) part of the MVC paradigm relating to the document manager 1081.

View

As noted previously, the canvas 2010 represents the logical layout of the document that is to be presented on the screen. For a specific example of an XHTML document, the canvas may include a box tree, which is the logical representation of how the document is viewed on the screen. Such a box tree would be included in the view (V) part of the MVC paradigm relating to the documents manager 1081.

Vocabulary Connection

A significant feature of the document processing management system is that a document can be represented and displayed in two different ways (for example, in two markup languages), such that consistency is maintained automatically between the two different representations.

A document in a markup language, for example in XML is created on the basis of a vocabulary that is defined by a document type definition. Vocabulary is in turn a set of tags. The vocabulary may be defined arbitrarily. This raises the possibility of having an infinite number of vocabularies. But then, it is impractical to provide separate processing and management environments that are exclusive for each of the multitude of possible vocabularies. Vocabulary connection provides a way of overcoming this problem.

For example, documents could be represented in two or more markup languages. The documents could, for example, be in XHTML (eXtensible HyperText Markup Language), SVG (Scalable Vector Graphics), MathML (Mathematical Markup Language), or other mark up languages. In other words, a markup language could be considered to be the same as a vocabulary and tag set in XML.

A vocabulary is implemented using a vocabulary plug-in. A document described in a vocabulary, whose plug-in is not available within the document processing and management system, is displayed by mapping the document to another vocabulary whose plug-in is available. Because of this feature, a document in a vocabulary, which is not plugged-in, could still be properly displayed.

Vocabulary connection includes capabilities for acquiring definition files, mapping between definition files and for generating definition files. A document described in a certain vocabulary can be mapped to another vocabulary. Thus, vocabulary connection provides the capability to display or edit a document by a display and editing plug-in corresponding to the vocabulary to which the document has been mapped.

As noted, each document is described within the document processing and management system as a DOM tree, typically having a plurality of nodes. A “definition file” describes for each note the connections between such node and other nodes. Whether the element values and attribute values of each node are editable is specified. Operation expressions using the element values or attribute values of nodes may also be described.

By use of a mapping feature, a destination DOM tree is created that refers to the definition file. Thus, a relationship between a source DOM tree and a destination DOM tree is established and maintained. Vocabulary connection monitors the connection between a source DOM tree and a destination DOM tree. On receiving an editing instruction from a user, vocabulary connection modifies a relevant node of the source DOM tree. A “mutation event,” which indicates that the source DOM tree has been modified, is issued and the destination DOM tree is modified accordingly.

By using vocabulary connection, a relatively minor vocabulary known to only a small number of users can be converted into another major vocabulary. Thus, a document can be displayed properly and a desirable editing environment can be provided, even with respect to a minor vocabulary that is utilized by a small number of users.

Thus, a vocabulary connection subsystem that is part of the document management system provides the functionality for making a multiple representation of the documents possible.

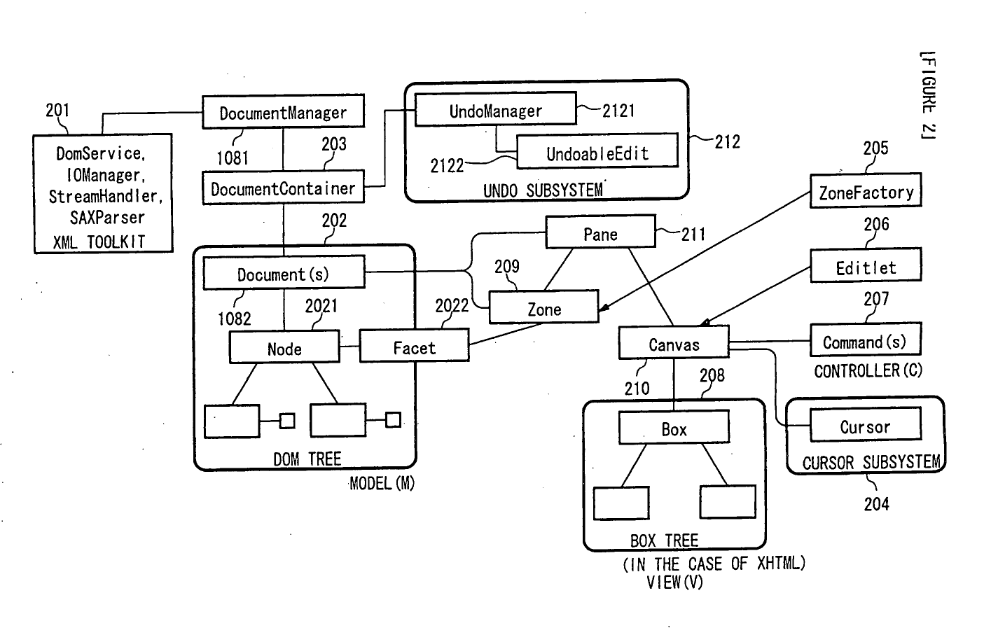

FIG. 3 shows the vocabulary connection (VC) subsystem 300. The VC system provides a way of maintaining consistency between two alternate representations of the same document. In the Figure, the same components, as previously illustrated and identified, appear and are interconnected to achieve that purpose. For example, the two representations could be alternate representations of the same document in two different vocabularies. As previously explained, one could be a source DOM tree and the other could be a destination DOM tree.

Vocabulary Connection Subsystem

The function of the vocabulary connection subsystem 300 is implemented in the document processing and management system using a plug-in called a “vocabulary connection” 301. For each vocabulary 305 in which a document is to be represented, a corresponding plug-in is required. For example, if a part of a document is represented in HTML and the rest in SVG, corresponding vocabulary plug-ins for HTML and SVG are required.

The vocabulary connection plug-in 301 creates the appropriate vocabulary connection canvases 310 for a zone 209 or a pane 211, which correspond to a document in the appropriate vocabulary 305. Using vocabulary connection 301, changes to a zone 209 in a source DOM tree is transferred to a corresponding zone in another DOM tree 306 using conversion rules. The conversion rules are written in the form of vocabulary connection descriptors (VCD). For each VCD file that corresponds to one such transfer between a source and a destination DOM, a corresponding vocabulary connection manager 302 is created.

Connector

A connector 304 connects a source node in source DOM tree and a destination node in a destination DOM tree. Connector 304 is operative to view the source node in the source DOM tree and the modifications (mutations) to the source document that correspond to the source node. It then modifies the nodes in the corresponding destination DOM tree. Connectors 304 are the only objects that can modify the destination DOM tree. For example, a user can make modifications only to the source document and the corresponding source DOM tree. The connectors 304 then make the corresponding modifications in the destination DOM tree.

Connectors 304 are linked together logically to form a tree structure. The tree formed by connectors 304 is called a “connector tree.” Connectors 304 are created using a service called the “connector factory” 303 service. The connector factory 303 creates connectors 304 from the source document and links them together in the form of a connector tree. The vocabulary connection manager 302 maintains the connector factory 303.

As discussed previously, a vocabulary is a set of tags in a namespace. As illustrated in FIG. 3, a vocabulary 305 is created for a document by the vocabulary connection 301. This is done by parsing the document file and creating an appropriate vocabulary connection manager 302 for the transfer between the source DOM and destination DOM. In addition, appropriate associations are made between the connector factory 303 that creates the connectors, the zone factory service 205 that creates the zones 209, and the editlet service 206 that create canvases corresponding to the nodes in the zones. When a user disposes of or deletes a document from the system, the corresponding vocabulary connection manager 302 is deleted.

Vocabulary 305 in turn creates the vocabulary connection canvas. In addition, connectors 304 and the destination DOM tree 306 are correspondingly created.

It should be understood that the source DOM and canvas correspond to a model (M) and view (V), respectively. However, such a representation is meaningful only when a target vocabulary can be rendered on the screen. Such a rendering is done by vocabulary plug-ins. Vocabulary plug-ins are provided for major vocabularies, for example XHTML, SVG and MathML. The vocabulary plug-ins are used in relation to target vocabularies. They provide a way for mapping among vocabularies using the vocabulary connection descriptors.

Such a mapping makes sense only in the context of a target vocabulary that is mappable and has a pre-defined way of being rendered on the screen. Such ways of rendering are industry standards, for example XHTML, which are defined by organizations such as W3C.

When there is a need for a vocabulary connection, a vocabulary connection canvas is used. In such cases, the source canvas is not created, as the view for the source cannot be created directly. In such a case a vocabulary connection canvas is created using a connector tree. Such a vocabulary connection canvas handles only event conversion and does not assist in the rendering of a document on the screen.

Destination Zones, Panes and Canvases

As noted above, the purpose of the vocabulary connection subsystem is to create and maintain concurrently two alternate representations for the same document. The second alternate representation also is in the form of a DOM tree, which previously has been introduced as a destination DOM tree. For viewing the document in the second representation, destination zones, canvases and panes are required.

Once the vocabulary connection canvas is created, corresponding destination panes 307 are created. In addition, the associated destination canvas 308 and the corresponding box tree 309 are created. Likewise, the vocabulary connection canvas is also associated with the pane 211 and zone 209 for the source document.

Destination canvas 308 provides the logical layout of the document in the second representation. Specifically, destination canvas 308 provides user interface functions, such as cursor and selection, for rendering the document in the destination representation. Events that occurred on the destination canvas 308 are provided to the connector. Destination canvas 308 notifies mouse events, keyboard events, drag and drop events and events original to the vocabulary of the destination (or the second) representation of the document to the connectors 304.

Vocabulary Connection Command Subsystem

An element of the vocabulary connection subsystem 300 of FIG. 3 is the vocabulary connection command subsystem 313. Vocabulary connection command subsystem 313 creates vocabulary connection commands 315 that are used for implementing instructions related to the vocabulary connection subsystem 300. Vocabulary connection commands can be created using built-in command templates 3131 and/or by creating the commands from scratch using a scripting language in a scripting system 314.

Examples of command templates include an “If” command template, a “When” command template, an “Insert fragment” command template, and the like. These templates are used to create vocabulary connection commands.

XPath Subsystem

XPath subsystem 316 is a key component of the document processing and managing system that assists in implementing vocabulary connection. The connectors 304 typically include XPath information. As noted above, a task of the vocabulary connection is to reflect changes in the source DOM tree onto the destination DOM tree. The XPath information includes one or more XPath expressions that are used to determine the subsets of the source DOM tree that need to be watched for changes/modifications.

Summary of Source DOM Tree Destination DOM Tree and the Connector Tree

The source DOM tree is a DOM tree or a zone that represents a document in a vocabulary prior to conversion to another vocabulary. The nodes in the source DOM tree are referred to as source nodes.

The destination DOM tree, on the other hand represents a DOM tree or a zone for the same document in a different vocabulary after conversion using the mapping, as described previously in relation to vocabulary connection. The nodes in the destination DOM tree are called destination nodes.

The connector tree is a hierarchical representation that is based on connectors, which represent connections between a source node and a destination node. Connectors view the source nodes and the modifications made to the source document. They then modify the destination DOM tree. In fact, connectors are the only objects that are allowed to modify the destination DOM trees.

### Event Flow in the Document Processing and Management System

In order to be useful, programs must respond to commands from the user. Events are a way to describe and implement user actions performed on program. Many higher level languages, for example Java, rely on events that describe user actions. Conventionally, a program had to actively collect information for understanding a user action and implementing it by itself. This could, for example, mean that, after a program initialized itself, it entered a loop in which it repeatedly looked to see if the user performed any actions on the screen, keyboard, mouse, etc, and then took the appropriate action. However, this process tends be unwieldy. In addition, it requires a program to be in a loop, consuming CPU cycles, while waiting for the user to do something.

Many languages solve these problems by embracing a different paradigm, one that underlies all modern window systems: event-driven programming. In this paradigm, all user actions belong to an abstract set of things called events. An event describes, in sufficient detail, a particular user action. Rather than the program actively collecting user-generated events, the system notifies the program when an interesting event occurs. Programs that handle user interaction in this fashion are said to be “event driven.”

This is often handled using an Event class which captures the fundamental characteristics of all user-generated events.

The document processing and management system defines and uses its own events and the way in which these events are handled. Several type of events are used. For example, a mouse event is an event originating from a user's mouse action. User actions involving the mouse are passed on to the mouse event by the canvas 210. Thus, the canvas can be considered to be at the forefront of interactions by a user with the system. As necessary, a canvas at the forefront will pass its event-related content on to its children.

A keystroke event, on the other hand, flows from the canvas 210. The key stroke event has an instant focus, that is, it relates to activity at any instant. The keystroke event entered onto the canvas 210 is then are passed on to its parents. Key inputs are processed by a different event that is capable of handling string inserts. The event that handles string inserts is triggered when characters are inserted using the keyboard. Other “events” include, for example, drag events, drop events, and other events that are handled in a manner similar to mouse events.

Handling of Events Outside Vocabulary Connection

The events are passed using event threads. On receiving the events, canvas 210 changes its state. If required, commands 1052 are posted to the command queue 1053 by the canvas 210.

Handling of Event Within Vocabulary Connection

With the use of the vocabulary connection plug-in 301, the destination canvas 1106 receives the existing events, like mouse events, keyboard events, drag and drop events and events original to the vocabulary. These events are then notified to the connector 1104. More specifically, the event flow within the vocabulary connection plug in 301 goes through source pane 1103, vocabulary canvas 1104, destination pane 1105, destination canvas 1106, destination DOM tree and the connector tree 1104, as illustrated in FIG. 11.

Program Invoker and Its Relation with Other Components

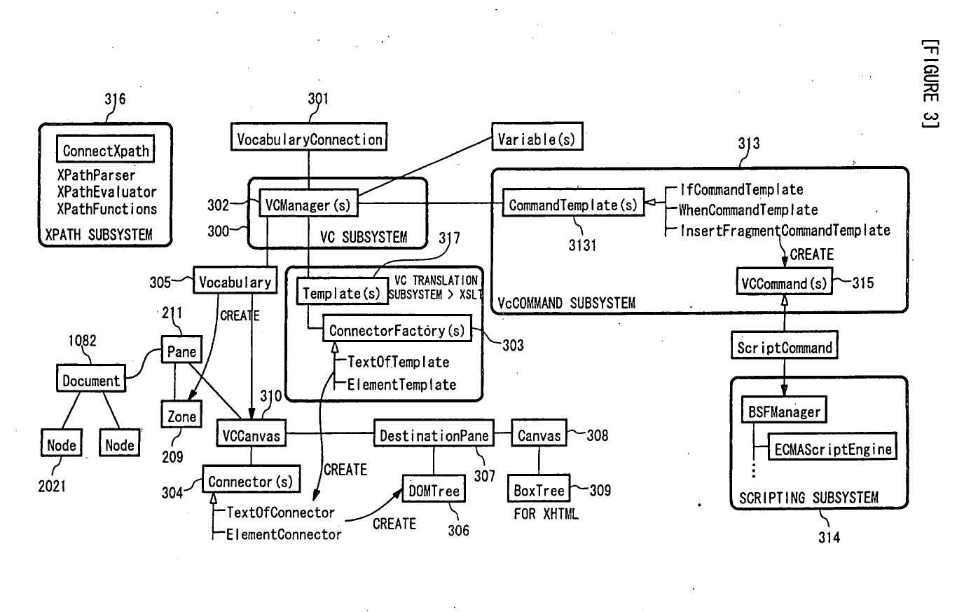

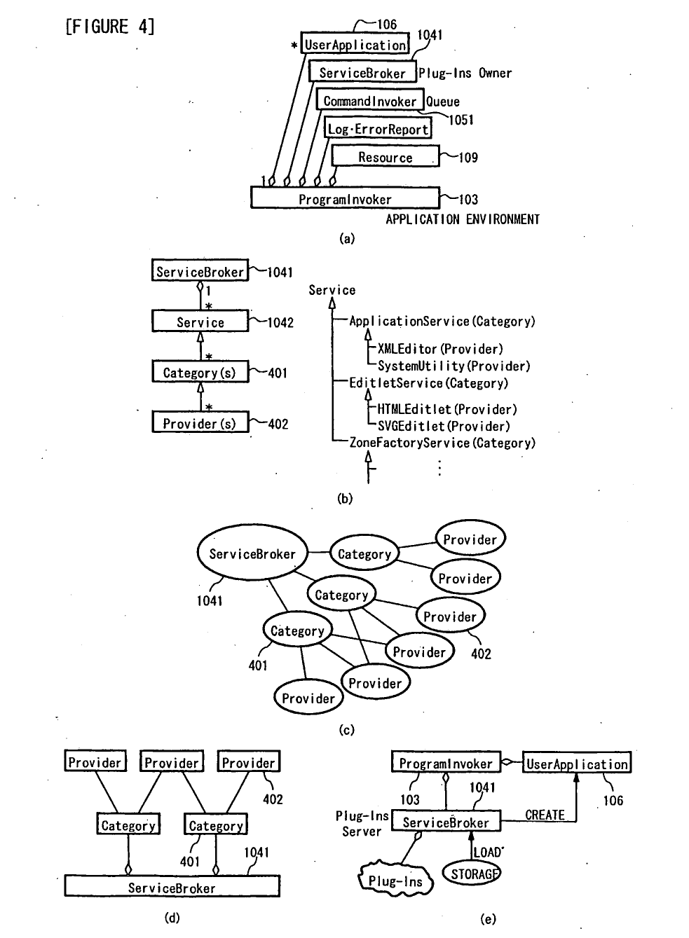

The program invoker 103 and its relation with other components is shown in FIG. 4(a) in further detail. Program invoker 103 is the basic program in the implementation environment that is executed to start the document processing and management system. The user application 106, service broker 1041, the command invoker 1051 and the resource 109 are all attached to the program invoker 103, as illustrated in FIG. 1B. As noted previously, the application 102 is the component that runs in the implementation environment. Likewise, the service broker 1041 manages the plug-ins that add various functions to the system. The command invoker 1051 on the other hand, maintains the classes and functions that are used to execute commands, thereby implementing the instructions provided by a user.

Plug-ins and Service

The service broker 1041 is discussed in further detail with reference to FIG. 4(b). As noted earlier, the service broker 1041 manages the plug-ins (and the associated services) that add various functions to the system. A service 1042 is the lowest level at which features can be added to (or changed within) the document processing and management system. A “service” consists of two parts; a service category 401 and a service provider 402. As illustrated in FIG. 4(c), a single service category 401 can have multiple associated service providers 402, each of which is operative to implement all or a portion of a particular service category. Service category 401, on the other hand, defines a type of service.

Services can be divided into three types: 1) a feature service, which provides a particular feature to the system, 2) an application service, which is an application to be run by the document processing and management system, and 3) an environment service, which provides features that are needed throughout the document processing and management system.

Examples of services are shown in FIG. 4(d). Under the category of application service, system utility is an examples of the corresponding service provider. Likewise editlet 206 is a category and HTML editlet and SVG editlets are the corresponding service providers. Zone factory 205 is another category of service and has corresponding service providers, not illustrated.

The plug-in that was previously described as adding add functionality to the document processing and management system, may be viewed as a unit that consists of several service providers 402 and the classes relating to them as shown in FIGS. 4(c) and 4(d). Each plug-in would have its dependencies and service categories 401 written in a manifest file.

Relation between program invoker and the application FIG. 4(e) shows further details on the relationships between the program invoker 103 and the user application 106. The required documents, data, etc are loaded from storage. All the required plug-ins are loaded onto the service broker 1041. The service broker 1041 is responsible for and maintains all plug-ins. Plug-ins can be physically added to the system, or its functionality can be loaded from a storage. Once the content of a plug-in is loaded, the service broker 1041 defines the corresponding plug-in. A corresponding user application 106 is created that then gets loaded onto the implementation environment 101 and gets attached to the program invoker 103.

Relation Between Application Service and the Environment

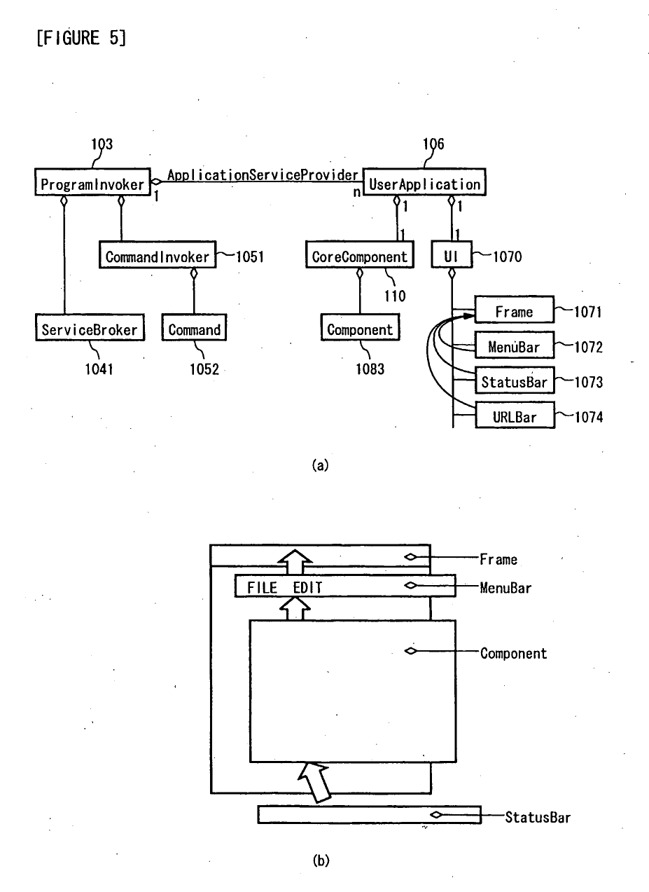

FIG. 5(a) provides further details on the structure of an application service loaded onto the program invoker 103. A command invoker 1051, which is a component of the command subsystem 105, invokes or executes commands 1052 within the program invoker 103. Commands 1052 in turn are instructions that are used for processing documents, for example in XML, and editing the corresponding XML DOM tree, in the document processing and management system. The command invoker 1051 maintains the functions and classes needed to execute the commands 1052.

The service broker 1041 also executes within the program invoker 103. The user application 106 in turn is connected to the user interface 107 and the core component 110. The core component 110 provides a way of sharing documents among all the panes. The core component 110 also provides fonts and acts as a toolkit for the panes.

FIGS. 5(a) and 5(b) show the relationships between a frame 1071, a menu bar 1072 and a status bar 1073.

### Application Core

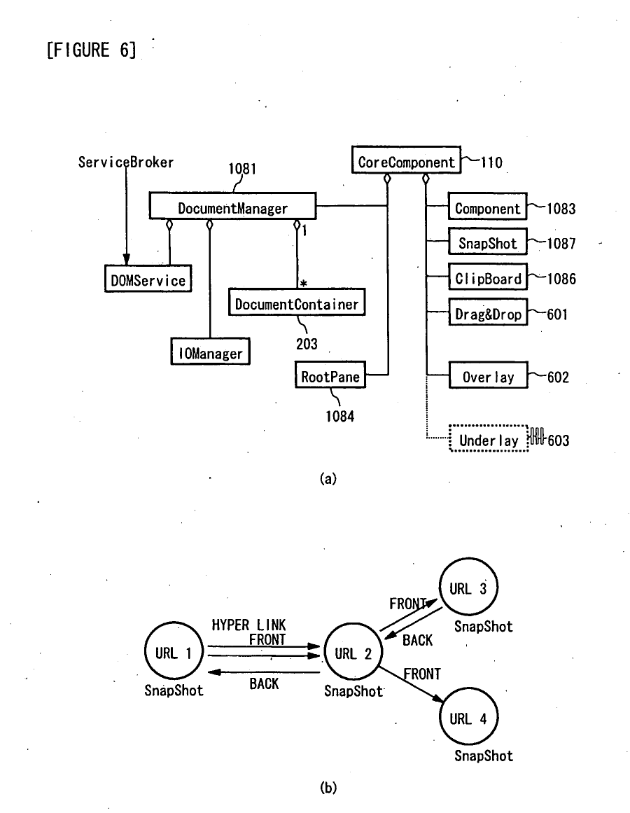

FIG. 6(a) provides additional explanations for the application core 110, that holds all the documents and the data that are part of and belong to the documents. The application core 110 is attached to the document manager 1081 that manages the documents 1082. Document manager 1081 is the proprietor of all the documents 1082 that are stored in the memory associated with the document processing and management system.

To facilitate the display of the documents on the screen, the document manager 1081 is also connected to the root pane 1084. Clip-board 1086, snapshot 1087, drag & drop 601 and overlay 602 functionalities are also attached to the application core.

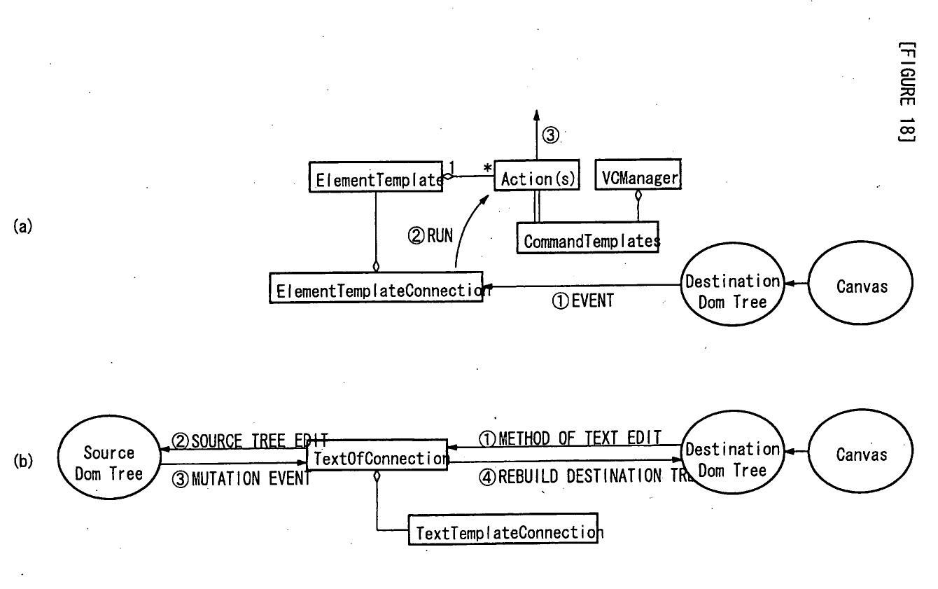

Snap shot 1087, as shown in FIG. 16(a) is used to undo an application state. When a user invokes the snap shot function 1087, the current state of the application is detected and stored. The content of the stored state is then saved when the state of the application changes to another state. Snap shot is illustrated in FIG. 6(b). In operation, as the application moves from one URL to the other, snapshot memorizes the previous state so that back and forward operations can be seamlessly performed.

### Organization of Documents Within the Document Manager

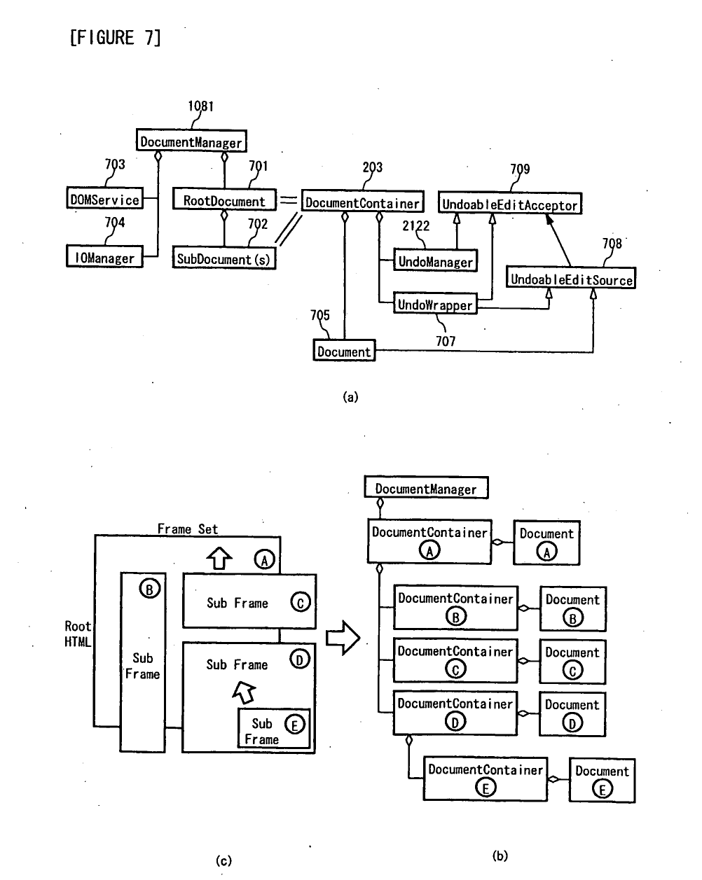

FIG. 7(a) provides further explanation for the document manager 1081 and how documents are organized and held in the document manager. As illustrated in FIG. 7(b), the document manager 1081 manages documents 1082. In the example shown in FIG. 7(a), one of the plurality of documents is a root document 701 and the remaining documents are subdocuments 702. The document manager 1081 is connected to the root document 701, which in turn is connected to all the sub-documents 702.

As illustrated in FIGS. 2 and 7(a), the document manager 1081 is coupled to the document container 203, which is an object that hosts all the documents 1082. The tools that form part of the toolkit 201 (for example XML toolkit), including DOM service 703 and the IO manager 704, are also provided to the document manager 1081. Again with reference to FIG. 7(a), the DOM service 703 creates DOM trees based on the documents which are managed by the document manager 1081. Each document 705, whether it is the root document 701 or a subdocument 702, is hosted by a corresponding document container 203.

FIG. 7(b) shows an example of how a set of documents A-E are arranged in a hierarchy. Document A is a root document. Documents B-D are sub documents of document A. Document E in turn is a subdocument of document D. FIG. 7(c) shows an example of how the same hierarchy of documents appear on a screen. The document A being a root document appears as a basic frame. Documents B-D, being sub documents of document A, appear as sub frames within the base frame A. Document E, being a sub document of document D, appears on the screen as a sub frame of the sub frame D.

Again with reference to FIG. 7(a), an undo manager 706 and an undo wrapper 707 are created for each document container 203. The undo manager 706 and the undo wrapper 707 are used to implement the undoable command. Using this feature, changes made to a document using an edit operation can be undone. A change in a sub-document has implications with respect to the root document as well. The undo operation takes into account the changes affecting other documents within the hierarchy and ensures that consistency is maintained among all the documents in the chain of hierarchy, as illustrated in FIG. 7(c), for example.

The undo wrapper 707 wraps undo objects that relate to the sub-documents in container 203 and couples them with undo objects that relate to the root document. Undo wrapper 707 makes the collection of undo objects available to the undoable edit acceptor 709. The undo manager 706 and the undo wrapper 707 are connected to the undoable edit acceptor 708 and undoable edit source 708. As would be understood by one skilled in the art, the document 705 may be the undoable edit source 708, and thus a source of undoable edit objects.

### Undo Command and Undo Framework

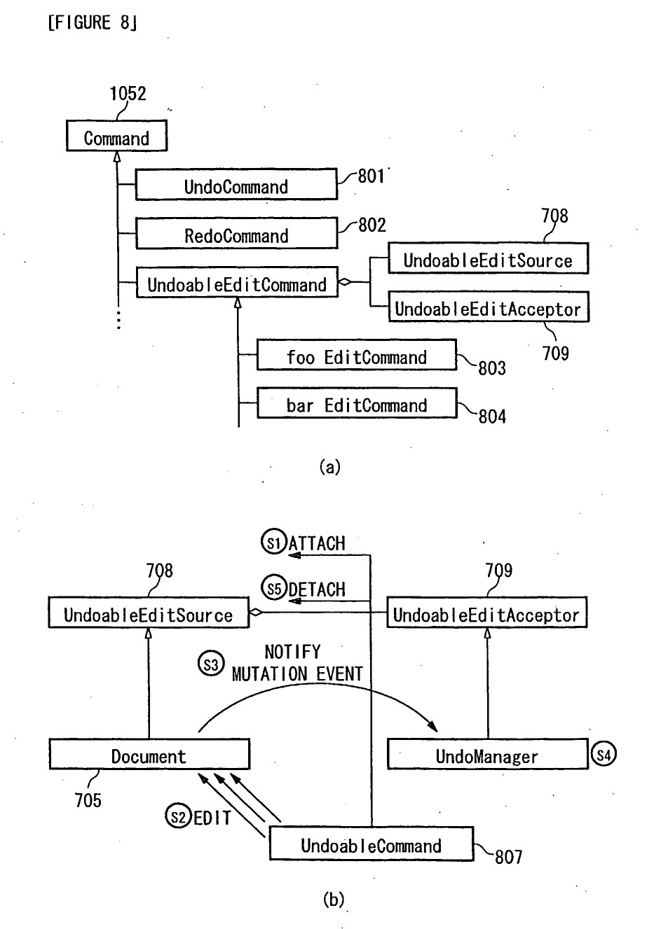

FIGS. 8(a) and 8(b) provide further details on the undo framework and the undo command. As shown in FIG. 8(a), undo command 801, redo command 802, and undoable edit command 803 are commands that can be queued in the command invoker 1051, as illustrated in FIG. 1(b), and executed accordingly. The undoable edit command 803 is further attached to undoable edit source 708 and undoable edit acceptor 709. Examples of undoable edit commands are a “foo” edit command 803 and “bar” edit command 804.

Execution of an Undoable Edit Command

FIG. 8(b) shows the execution of an undoable edit command. First, it is assumed that a user edits a document 705 using an edit command. In the first step S1, the undoable edit acceptor 709 is attached to the undoable edit source 708, which is a DOM tree for the document 705. In the second step S2, based on the command that was issued by the user, the document 705 is edited using DOM APIs. In the third step S3, a mutation event listener is notified that a change has been made. That is, in this step a listener that monitors all the changes in the DOM tree detects the edit operation. In the fourth step S4, the undoable edit is stored as an object with the undo manager 706. In the fifth step S5, the undoable edit acceptor 709 is detached from the source 708, which may be the document 705 itself.

### Steps Involved in Loading a Document to the System

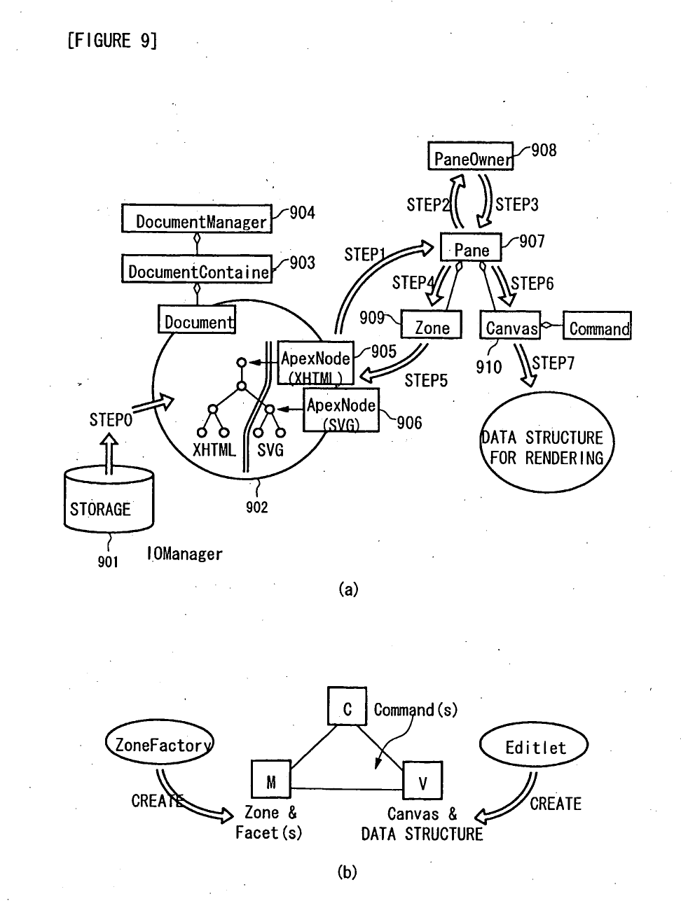

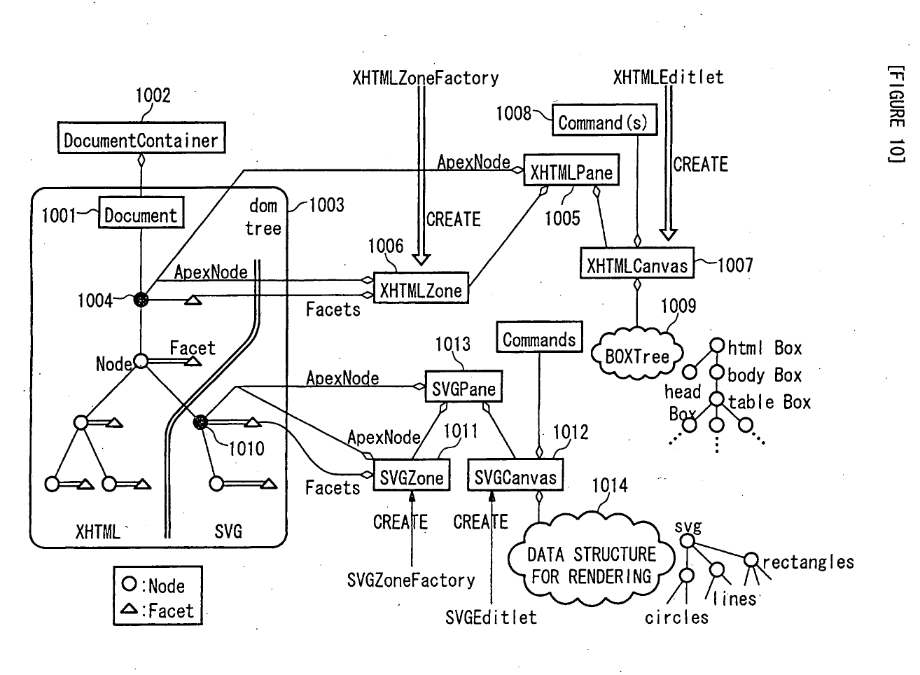

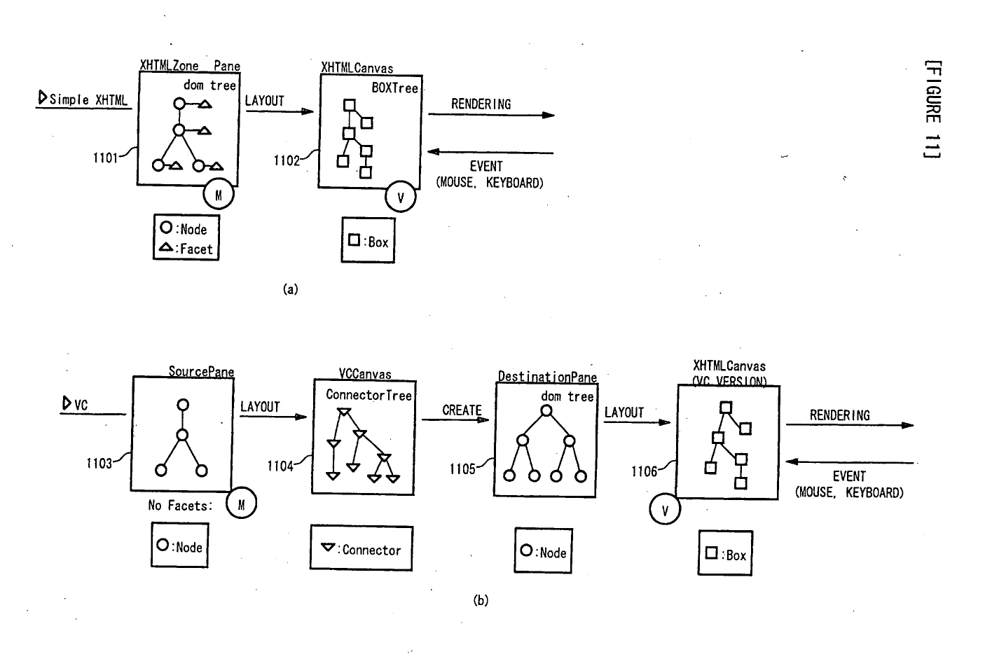

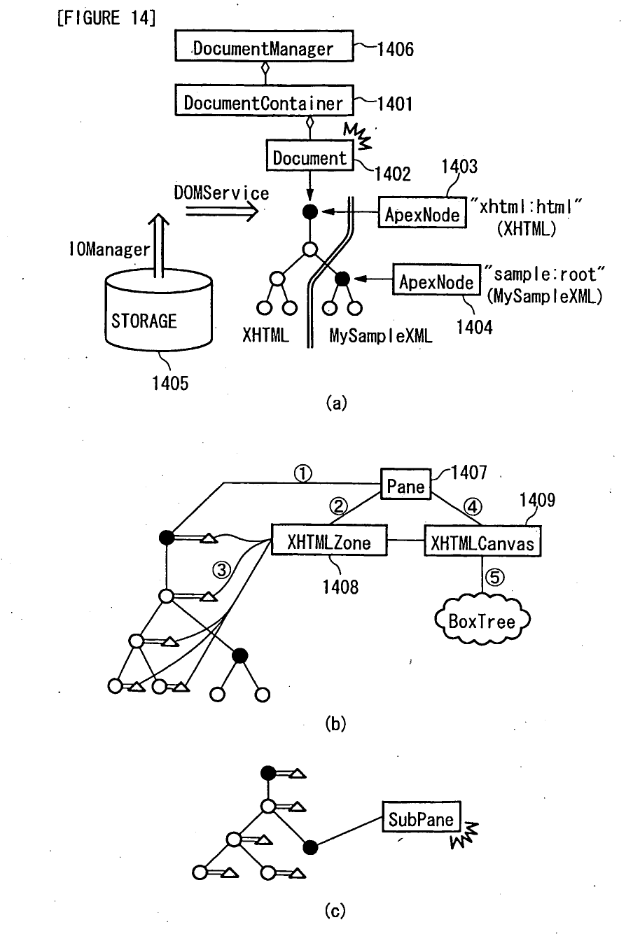

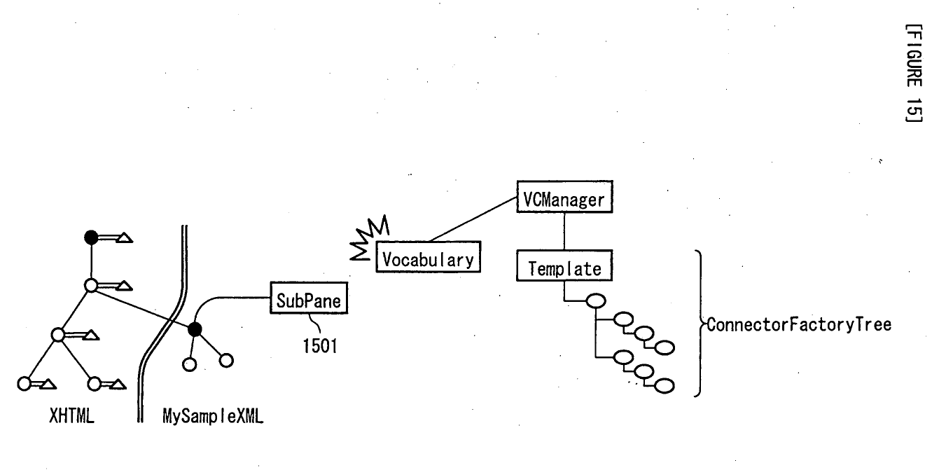

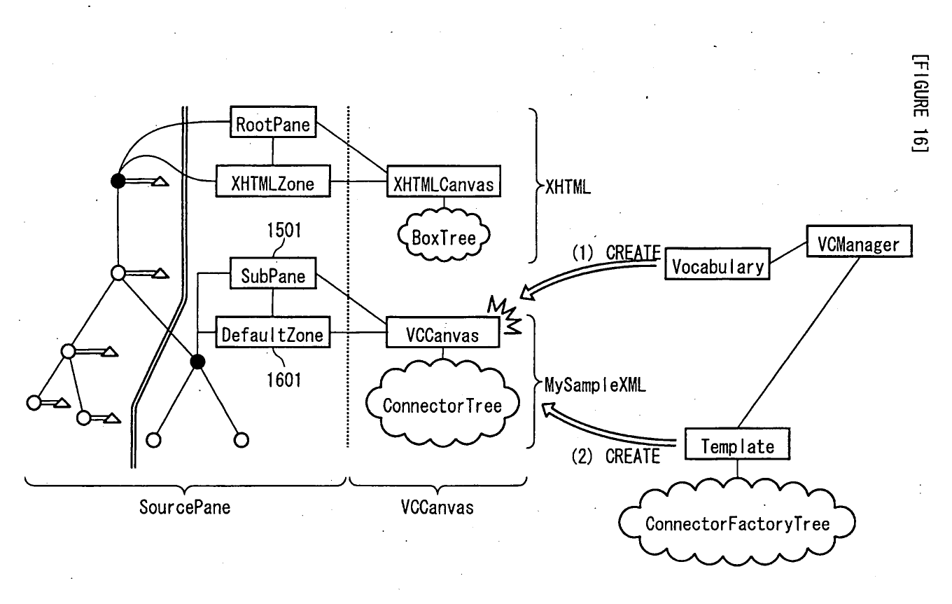

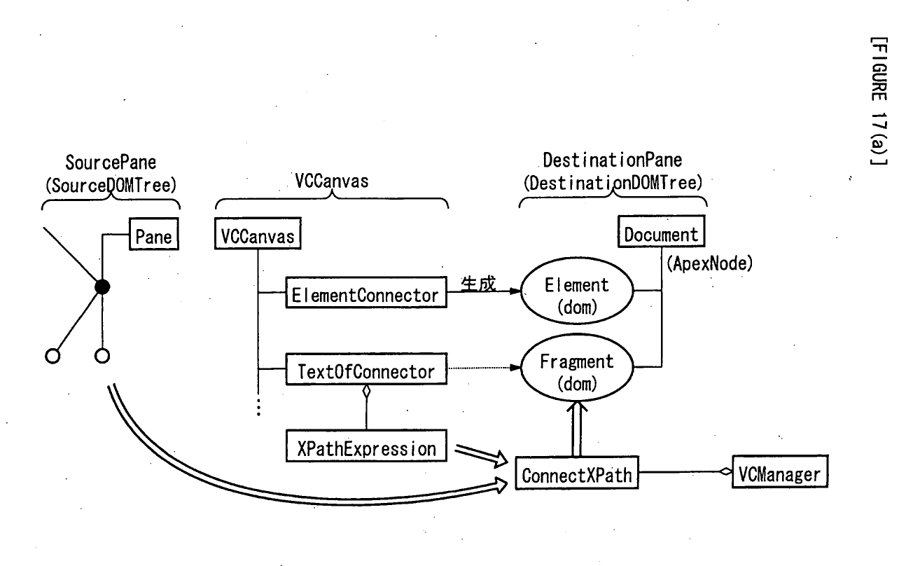

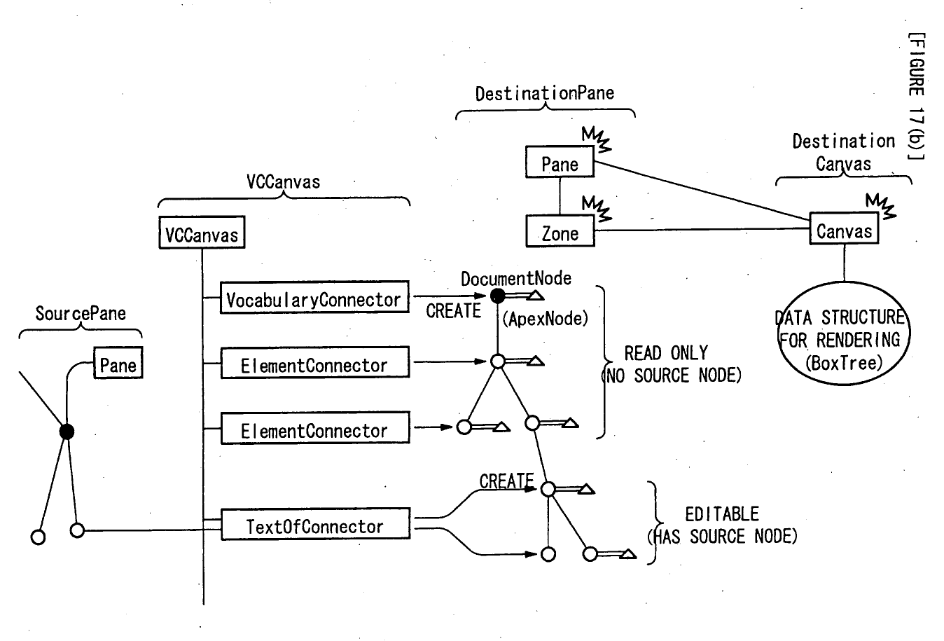

The previous subsections describe the various components and subcomponents of the system. The methodology involved in using these components is described hereunder. FIG. 9 shows an overview of how a document is loaded in the document processing and management system. Each of the steps are explained in greater detail with reference to a specific example in FIGS. 14-18.

In brief, the document processing and management system creates a DOM tree from a binary data stream consisting of the data contained in the document. An apex node is created for a part of the document that is of interest and resides in a “zone”, and a corresponding “pane” is then identified. The identified pane creates “zone” and “canvas” from the apex node and the physical screen surface. The “zone” in turn create “facets” for each of the nodes and provides the needed information to them. The canvas creates data structures for rendering the nodes from the DOM tree.

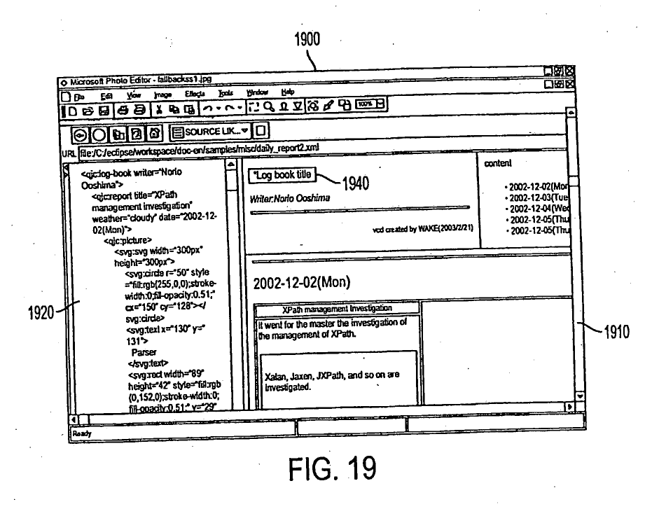

Specifically, with reference to FIG. 19(a), a complex document representing both SHTML and SVG content is loaded from storage 901 in a “step 0.”. A DOM tree 902 for the document is created. Note that the DOM tree has an apex node 905 (XHTML) and that, as the tree descends to other branches, a boundary is encountered as designated by a double line, followed by an apex node 906 for a different vocabulary, SVG. This representation of the complex document is useful in understanding the manner in which the document is represented and ultimately rendered for display.

Next, a corresponding document container 903 is created that holds the document. The document container 903 is then attached to the document manager 904. The DOM tree includes a root node and, optionally, a plurality of secondary nodes.

Typically, such a document includes has both text and graphics. Therefore, the DOM tree, for example, could have an XHTML sub tree as well as an SVG sub tree. The XHTML sub tree has an XHTML apex node 905. Likewise, the SVG sub tree has an SVG apex node 906.

Again with reference to FIG. 9(a),in step 1, the apex node is attached to a pane 907, which is the logical layout for the screen. In step 2, the pane 907 requests the application core 908 for a zone factory for the apex node. In step 3, the application core 908 returns a zone factory and an editlet, which is a canvas factory for the apex node 906.

In step 4, the pane 907 creates a zone 909, which is attached to the pane. In step 5, the zone 909 in turn creates a facet for each node and attaches to the corresponding node. In step 6, the pane creates a canvas 910, which is attached to the pane. Various commands are include in the canvas 910. The canvas 910 in turn constructs data structures for rendering the document to the screen. In case of XHTML, this includes the box tree structure.

MVC for the Zone

FIG. 9(b) shows a summary of the structure for the zone, using the MVC paradigm. The model (M) in this case includes the zone and the facets, since these are the inputs related to a document. The view (V) corresponds to the canvas and the data structure for rendering the document on the screen, since these are the outputs that a user sees on the screen. The control (C) includes the commands that are included in the canvas, since the commands perform the control operation on the document and its various relationships.

### Representation for a Document

An example of a document and its various representations are discussed subsequently, using FIG. 10. The document used for this example includes both text and pictures. The text is represented using XHTML and the pictures are represented using SVG. FIG. 10 shows the MVC representation for the components of the document and the relation of the corresponding objects in detail. For this exemplary representation, the document 1001 is attached to a document container 1002 that holds the document 1001. The document is represented by a DOM tree 1003. The DOM 1003 tree includes an apex node 1004 and other nodes in descent, having corresponding facets as previously explained with respect to FIG. 9(a).

Apex nodes are represented by shaded circles. Non-apex nodes are represented by non-shaded circles. Facets, that are used to edit nodes, are represented by triangles and are attached to the corresponding nodes. Since the document has text and pictures, the DOM tree for this document includes an XHTML portion and an SVG portion. The apex node 1004 is the top-most node for the XHTML sub tree. This is attached to an XHTML pane 1005, which is the top most pane for the physical representation of the XHTML portion of the document. The apex node is also attached to an XHTML zone 1006, which is part of the DOM tree for the document 1001.

The facet 1041 corresponding to the node 1004 is also attached to the XHTML zone 1006. The XHTML zone 1006 is in turn attached to the XHTML pane 1005. An XHTML editlet creates an XHTML canvas 1007, which is the logical representation for the document. The XHTML canvas 1007 is attached to the XHTML pane 1005. The XHTML canvas 1007 creates a box tree 1009 for the XHTML component of the document 1001. Various commands 1008, which are required to maintain and render the XHTML portion of the document, are also added to the XHTML canvas 1005.

Likewise the apex node 1010 for the SVG sub-tree for the document is attached to the SVG zone 1011, which is part of the DOM tree for the document 1001 that represents the SVG component of document. The apex node 1010 is attached to the SVG pane 1013, which is the top most pane for the physical representation of the SVG portion of the document. SVG canvas 1012, which represents the logical representation of the SVG portion of the document, is created by the SVG editlet and is attached to the SVG pane 1013. Data structures and commands for rendering the SVG portion of the document on the screen are attached to the SVG canvas. For example, such a data structure could include circles, lines, rectangles, etc., as shown.

Parts of the representation for the example document, discussed in relation to FIG. 10 are further discussed in connection with the illustration in FIGS. 11(a) and 11(b), using the MVC paradigm described earlier. FIG. 11(a) provides a simplified view of the MV relationship for the XHTM component for the document 1001. The model is an XHTM zone 1103 for the XHTML component of the document 1001. Included in the XHTML zone tree are several nodes and their corresponding facets. The corresponding XHTML zone and the pane are part of the model (M) portion of the MVC paradigm. The view (V) portion of the MVC paradigm is the corresponding XHTML 1102 canvas and the box tree for the HTML component of the document 1001. The XHTML portion of the documents is rendered to the screen using the canvas and the commands contained therein. The events, such as keyboard and mouse inputs, proceed in the reverse directions as shown.

The source pane has an additional function, that is, to act as a DOM holder. FIG. 11(b) provides a vocabulary connection for the component of the document 1001 shown in FIG. 11(a). A source pane 1103, acting as the source DOM holder, contains the source DOM tree for the document. A connector tree 1104 is created by the connection factory, which in turn creates a destination pane 1105, that also serves as a destination DOM holder. The destination pane 1105 is then laid out as an XHTML destination canvas 1106 in the form of a box tree.

Relationships between Plug-In Subsystem, Vocabulary Connection and Connectors

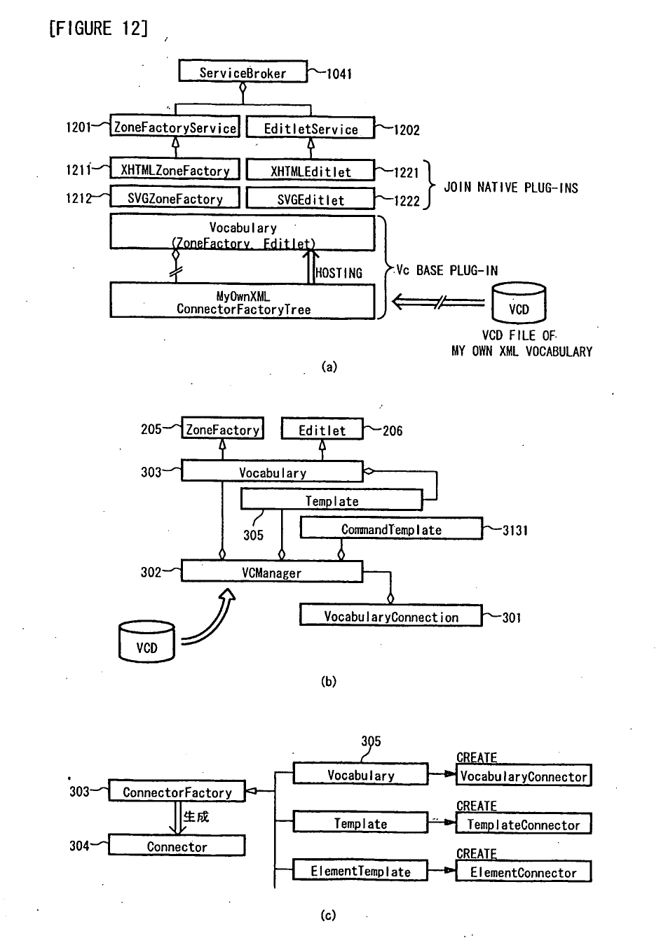

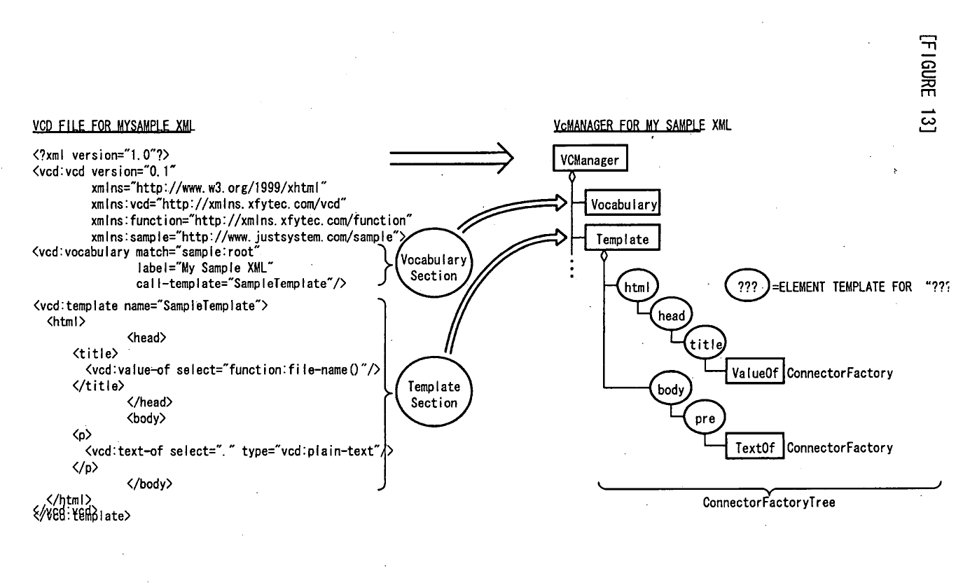

FIGS. 12(a)-(c) shows additional details related to the plug-in sub-system, vocabulary connections and connector, respectively. The plug-in subsystem system is used to add or exchange functions with the document processing and management system. The plug-in sub-system includes a service broker 1041. As illustrated in FIG. 12(a), a VCD file of “My Own XML vocabulary” is coupled to a VC Base plug-in, comprising a MyOwnXML connector factory tree and vocabulary (Zone Factory Builder). The zone factory service 1201, which is attached to the service broker 1041, is responsible for creating zones for parts on the document. The editlet service 1202 is also attached to the service broker. The editlet service 1202 creates canvases corresponding to the nodes in the zone.

Examples of zone factories are XHTML zone factory 1211 and SVG Zone factory 1212, which create XHTML zones and SVG zones, respectively. As noted previously in relation to an example document, the textual component of the document could be represented by creating an XHTML zone and the pictures could be represented using the SVG zone. Examples of editlet service includes XHTML editlet 1221 and SVG editlet 1222.

FIG. 12(b) shows additional details related to vocabulary connection, which as described above, is a significant feature of the document processing and management system that enables the consistent representation and display of documents in two different ways. The vocabulary connection manager 302, which maintains the connector factory 303, is part of the vocabulary connection subsystem and is coupled to the VCD to receive vocabulary connection descriptors and to generate vocabulary connection commands 301. As illustrated in FIG. 12(c), the connector factory 303 creates connectors 304 for the document. As discussed earlier, connectors view nodes in the source DOM and modifies the nodes in the destination DOM to maintain consistency between the two representations.

Templates 317 represent conversion rules for some nodes. In fact, a vocabulary connection descriptor file is a list of templates that represent some rules for converting an element or a set of elements that satisfy certain path or rules to other elements. The vocabulary template 305 and command template 3131 are all attached to the vocabulary connection manager 302. The vocabulary connection manager is the manager object of all sections in the VCD file. One vocabulary connection manager object is created for one VCD file.

FIG. 12(c) provides additional details related to the connectors. Connector factory 303 creates connectors from the source document. The connector factory is attached to vocabulary, templates and element templates and creates vocabulary connectors, template connectors and element connectors, respectively.

The vocabulary connection manager 302 maintains the connector factor 303. To create a vocabulary, the corresponding VCD file is read. The connector factory 303 is then created. This connector factor 303 is associated with the zone factory that is responsible for creating the zones and the editlet service that is responsible for creating the canvas.

The editlet service for the target vocabulary then creates a vocabulary connection canvas. The vocabulary connection canvas creates nodes for the destination DOM tree. The vocabulary connection canvas also creates the connector for the apex element in the source DOM tree or the zone. The child connectors are then created recursively as needed. The connector tree is created by a set of templates in the VCD file.

The templates in turn are the set of rules for converting elements of a markup language into other elements. For example, each template is matched with the source DOM tree or zone. In case of an appropriate match, an apex connector is created. For example, a template “A/*/D” watches all the branches of the tree starting with a node A and ending with a node D, regardless of what the nodes are in between. Likewise “//B” would correspond to all the “B” nodes from the root.

### Example of a VCD File Related Connector Trees

An example explaining the processing related to a specific document follows. A document titled MySampleXML is loaded into the document processing system. FIG. 13 shows an example of VCD script using vocabulary connection manager and the connector factory tree for the file MySampleXML. The vocabulary section, the template section within the script file and their corresponding components in the vocabulary connection manager are shown. Under the tag “vcd: vocabulary” the attributer match=“sample:root”, label=“MySampleXML” and cell-template—“sampleTemplate” is provided.

Corresponding to this example, the vocabulary includes apex element as “sample:root” in the vocabulary connection manager for MySampleXML. The corresponding UI label is “MySampleXML. In the template section the tag is vcd:template and the name is “sample template.”

Detailed Example of How a File is Loaded into the System

FIGS. 14-18 show a detailed description of loading the document MySampleXML. In step 1, shown in FIG. 14(a), the document is loaded from storage 1405. The DOM service creates a DOM tree and the document manager 1406 a corresponding document container 1401. The document container is attached to the document manager 1406. The document includes a subtree for XHTML and MySampleXML. The XHTML apex node 1403 is the top-most node for XHTML with the tag xhtml:html. On the other hand, mysample Apex node 1404 corresponds to mySampleXML with the tag sample:root.

In step 2, shown in FIG. 14(b) the root pane creates XTML zones, facets and canvas for the document. A pane 1407, XHTML zone 1408, XHTML canvases 1409 and a box tree 1410 are created corresponding to the apex node 1403.

In step 3, shown in FIG. 14(c), the XHTML zone finds a foreign tag “sample:root” and creates a sub pane from a region on the html canvas.

FIG. 15 shows step 4, where the sub pane gets a corresponding zone factory that can handle the “sample:root” tag and create appropriate zones. Such a zone factory will be in a vocabulary that can implement the zone factory. It includes the contents of the vocabulary section in MySampleXML.

FIG. 16 shows step 5, where vocabulary corresponding to MySampleXML creates a default zone 1601. A corresponding editlet is created and provided to sub pane 1501 to create a corresponding canvas. The editlet creates the vocabulary connection canvas. It then calls the template section. The connector factory tree is also included. The connector factory tree creates all the connectors which are then made into the connector tree that forms part of a VC Canvas. The relationship of the root pane and XHTML zone, as well as XHTML Canvas and box tree for the apex node that relates to the XHTML content of the document is readily apparent from the previous discussion.

FIG. 17(a), on the basis of the correspondence among the Source DOM tree, VC canvas and Destination DOM tree as previously explained, shows step 6, where each connector then creates the destination DOM objects. Some of the connectors include XPath information. The XPath information includes one or more XPath expressions that are used to determine the subsets of the source DOM tree that need to be watched for changes/modifications.

FIG. 17(b) , according to the source, VC and destination relationship, shows step 7, where the vocabulary makes a destination pane for the destination DOM tree from the pane for the source DOM. This is done based on the source pane. The apex node of the destination tree is then attached to the destination pane and the corresponding zone. The destination pane is then provided with its own editlet, which in turn creates the destination canvas and constructs the data structures and commands for rendering the document in the destination format.

FIG. 18(a) shows a flow of an event that has occurred on a node that does not have a corresponding source node and dependent on a destination tree alone. Events acquired by a canvas such as a mouse event and a keyboard event pass through a destination tree and are transmitted to ElementTemplateConnector. ElementTemplateConnector does not have a corresponding source node, so that the transmitted event is not an edit operation on a source node. In case the transmitted event matches a command described in CommandTemplate, ElementTemplateConnector executes a corresponding action. Otherwise, ElementTemplateConnector ignores the transmitted event.

FIG. 18(b) shows a flow of an event which has occurred on a node of a destination tree which is associated with a source node by TextOfConnector. TextOfConnector acquires a text node from a node specified by XPath of a source DOM tree and maps the text node to a node of the destination DOM tree. Events acquired by a canvas such as a mouse event and a keyboard event pass through a destination tree and are transmitted to TextOfConnector. TextOfConnector maps the transmitted event to an edit command of a corresponding source node and stacks the command in a queue 1053. The edit command is a set of API calls associated with the DOM and executed via a facet. When the command stacked in a queue is executed, a source node is edited. When the source node is edited, a mutation event is issued and TextOfConnector registered as a listener is notified of the modification to the source node. TextOfConnector rebuilds a destination tree so as to reflect the modification to the source node on the corresponding destination node. In case a template including TextOfConnector includes a control statement such as “for each” and “for loop”, Connectorfactory reevaluates the control statement. After TextOfConnector is rebuilt, the destination tree is rebuilt.

Details of the Creating a Tag or Attribute Operation

FIG. 19 illustrates a split screen 1900, wherein a user interface 1910 is shown on the right side of the figure and the corresponding markup language code 1920 is shown on the left side of the figure. The interface that is shown is that of a daily-report file. The markup language shown in extensible markup language. The user interface 1910 contains several fields, including the “*log book title” field 1940 at the top portion of the interface portion 410 of FIG. 4. This “*log book title” field 440 is further discussed below.

The “*log book title” field 1940 is referred to hereinafter as a fallback section. If any character is input into the fallback section, the “*log book title” phrase disappears. And if there is no pre-existing “title” tag (in the XML) that corresponds to the fallback section, then such title tag is created.

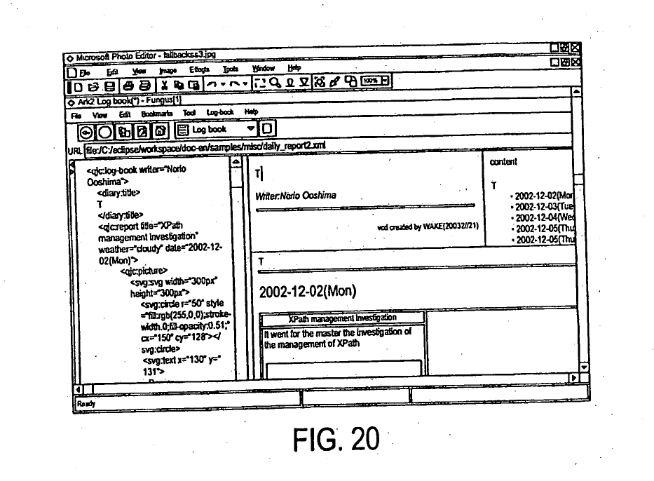

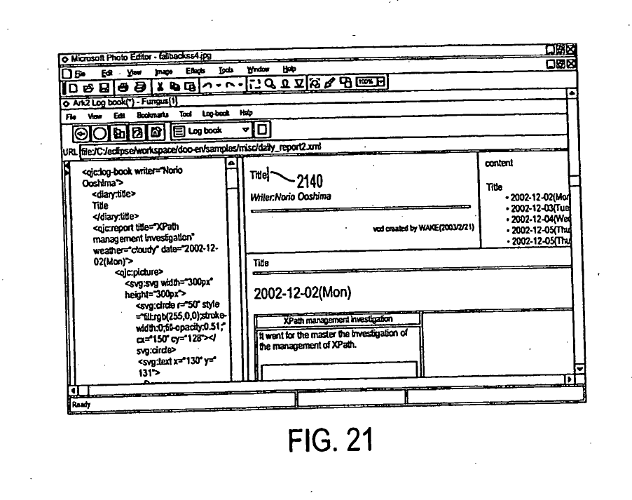

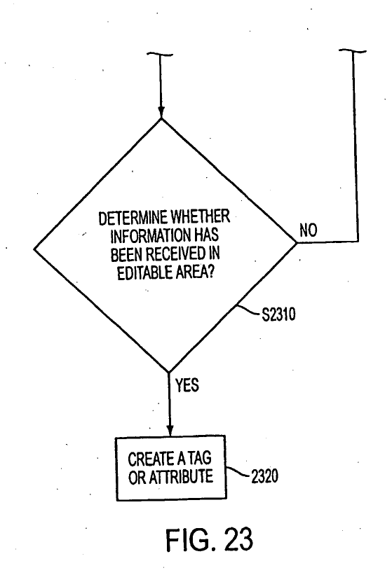

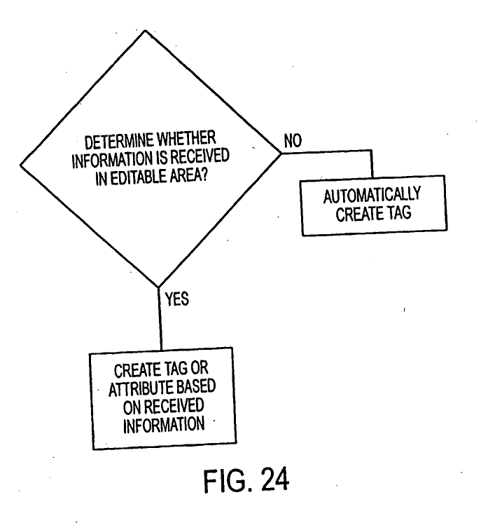

For example, as shown in FIG. 20, a character (here “T”) is entered into the fallback section 540. Then, a title tag (diary:title) is created after a determination is made that input has been received (S2310 in FIG. 23), and a “T” is input as the text value for this created tag. Further, as shown in FIG. 21, as further text is entered into the fallback section 2140, that same text is entered as the text value of the created title tag (FIG. 21). According to an exemplary embodiment of the present invention, a title tag is not created until text is input into its corresponding fallback section (S2320 in FIG. 23).

As alternative embodiment, a tag can be automatically created when there is no information received in the editable area.

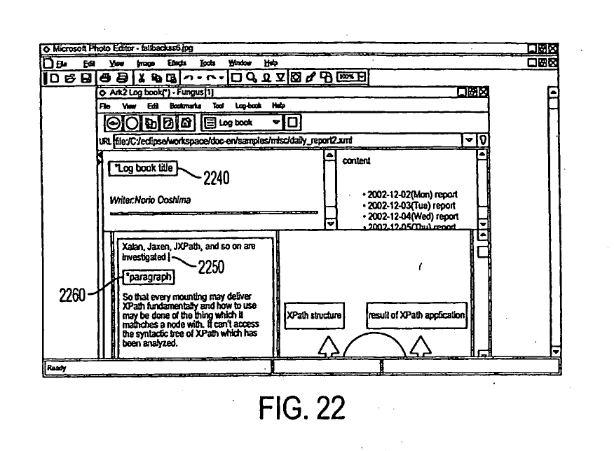

Another aspect of the invention, according to an exemplary embodiment, is that cursor movement is different from that of other conventional art that include modal dialogues. For example, according to an exemplary embodiment of the present invention, when a cursor located in a fallback section 2240, pressing the right arrow key has an effect of moving the cursor out of the fallback section 2240. For example, as shown in FIG. 22, if a cursor is in the fallback section “*log book title” and a right arrow key is depressed, then the cursor moves to the next editable field 2250. Here, as shown in FIG. 22, the cursor would move to the field 2250 that includes plain text. If a right arrow key is depressed again, then the cursor would move to the second fallback section 2260 labeled “*paragraph”. Further, if the right arrow key is pressed yet once again, then the cursor moves to the lower plain-text section that starts with the text “So that every mounting . . . ”. Therefore, by using a key such as the right arrow key, a cursor can be moved from one editable field to another instead of moving character by character within a field.

Also, yet another exemplary aspect of the present invention is that a user interface can be formed based on source document based on a VCD, the change rule.

The foregoing embodiments and advantages are merely exemplary and are not to be construed as limiting the present invention. The description of the present invention is intended to be illustrative, and is not intended to limit the scope of the claims. Many alternatives, modifications, and variations will be apparent to those skilled in the art.

What is claimed is:

1. A method of creating one of a tag and an attribute in a markup language document, said method comprising:
determining whether information is received in an editable area of an interface; and
if said information is received, creating said one of said tag and said attribute based on the received information.

2. The method according to claim 1, wherein said one of said tag and said attribute is created only when said information is received in said editable area.

3. The method according to claim 1, wherein said markup language is extensible markup language (XML).

4. The method according to claim 1, wherein said interface is a user interface.

5. The method according to claim 1, wherein when a cursor is located in said editable area, pressing a key moves said cursor to a next editable area.

6. The method according to claim 1, wherein said key is a right arrow key.

7. The method according to claim 1, wherein if no information is in said editable field, a tag is automatically created.

8. The method according to claim 1, wherein if a fragment is inserted in said markup language document, a corresponding editable area is created in said interface.

9. The method according to claim 8, wherein said markup language is an extensible markup language (XML).

10. The method according to claim 1, wherein said markup language document represents the document object model (DOM).

11. The method according to claim 8, wherein said fragment is at least one tag.

12. The method according to claim 8, wherein said fragment is at least one attribute.

13. The method according to claim 8, wherein said fragment is text.

14. The method according to claim 8, wherein said fragment includes one or more markup language components.

15. The method according to claim 1, wherein said a configuration of editable area determines which of said one of said tag and said attribute is created.

16. The method according to claim 1, wherein said a configuration of editable area determines where said one of said tag and said attribute is created in said markup language document.

17. A system for editing, by a user, a markup language document, said system comprising:
a display unit having an editable area;
a conversion unit which adds one of a tag and an attribute to said markup language document based on whether said editable area is edited.

18. The system according to claim 17, wherein only adding information to said editable area results in the creation of said one of said tag and said attribute.

19. The system according to claim 17, wherein said markup language is extensible markup language (XML).

20. The system according to claim 17, wherein when a cursor is located in said editable area, pressing a key moves said cursor to a next editable area.

21. The system according to claim 20, wherein said key is a right arrow key.

22. A system for editing a first markup language document in order to reflect changes in a second markup language document, said system comprising:
said first markup language document having an editable area;
a conversion unit which adds one of a tag and an attribute to said second markup language document based on whether said editable area is edited.

23. The system according to claim 22, wherein only adding information to said editable area results in the creation of said one of said tag and said attribute.

24. The system according to claim 22, wherein said markup language is an extensible markup language (XML).

25. The system according to claim 17, wherein if no information is provided in said editable field, said tag is automatically created.

26. The system according to claim 22, wherein if no information is provided in said editable field, said tag is automatically created.

27. The system according to claim 22, wherein when a cursor is located in said editable area, pressing a key moves said cursor to a next editable area.

28. The system according to claim 26, wherein said key is a right arrow key.

29. The system according to claim 17, wherein if a fragment is inserted in said markup language document, a corresponding editable area is created in said display unit.

30. The system according to claim 28, wherein said markup language is an extensible markup language (XML).

31. The system according to claim 17, wherein said markup language document represents a document object model (DOM).

32. The system according to claim 28, wherein said fragment is at least one tag.

33. The system according to claim 28, wherein said fragment is at least one attribute.

34. The system according to claim 28, wherein said fragment is text.

35. The system according to claim 28, wherein said fragment includes one or more markup language components.

36. The system according to claim 17, wherein said a configuration of said editable area determines which of said one of said tag and said attribute is created.

37. The system according to claim 17, wherein said a configuration of said editable area determines where said one of said tag and said attribute is created in said markup language document.

38. The system according to claim 17, further comprising an editable area formation unit for creating one or more editable areas in said display unit based on information input into said markup language document.

39. An interface that based on a markup language, comprising:
an editable area,
wherein said editable area determines whether one of a tag and an attribute is created.

40. A user interface based on an extensible markup language (XML), said user interface comprising:
an editable area,
wherein said editable area determines whether one of a tag and an attribute is created in a source document.

41. The interface according to claim 38, wherein only adding information to said editable area results in the creation of said one of said tag and said attribute.

42. The interface according to claim 38, wherein said markup language is an extensible markup language (XML).

43. The interface according to claim 38, wherein the interface is a user interface.

44. The interface according to claim 38, wherein when a cursor is located in said editable area, pressing a key moves cursor to a next editable field.

45. The interface according to claim 43, wherein said key is a right arrow key.

46. The interface according to claim 40, wherein character data is displayed in said editable area before said information is added.

47. The interface according to claim 38, wherein said information is character data.

48. The interface according to claim 45, wherein said character data disappears when said information is added.

49. The interface according to claim 38, wherein if no information is provided in said editable field, said tag is automatically created.

50. The interface according to claim 38, wherein if a fragment is inserted in said markup language document, a corresponding editable area is created.

51. The interface according to claim 49, wherein said markup language is an extensible markup language (XML).

52. The interface according to claim 38, wherein said markup language document represents a document object model (DOM).

53. The interface according to claim 49, wherein said fragment is at least one tag.

54. The interface according to claim 49, wherein said fragment is at least one attribute.

55. The interface according to claim 49, wherein said fragment is text.

56. The interface according to claim 49, wherein said fragment includes one or more markup language components.

57. A method of creating, using a markup language, an environment used to create one of a tag and an attribute, said method comprising:
creating, using said markup language, an interface including an editable area, said interface being part of said environment;
wherein said editable area determines whether said one of said tag and said attribute is created.

58. The method according to claim 56, wherein adding information to said editable area determines whether said one of said tag and said attribute is created.

59. The method according to claim 56, wherein said markup language is an extensible markup language (XML).

60. The method according to claim 56, wherein said interface is a user interface.

61. The method according to claim 56, wherein when a cursor is located in said editable area, pressing a key moves said cursor to a next editable field.

62. The method according to claim 56, wherein said key is a right row key.

63. The method according to claim 56, wherein if no information is provided in said editable field, said tag is automatically created

64. A computer program product including computer readable media comprising instructions to enable a computer to implement a method of creating one of a tag and an attribute in a markup language document, said method comprising:
receiving information in an editable area of an interface;
creating said one of said tag and said attribute based on the received information.

65. The computer program product according to claim 63, wherein said one of said tag and said attribute is created only when said information is received.

66. The computer program product according to claim 63, wherein said markup language is extensible markup language (XML).

67. The computer program product according to claim 63, wherein said interface is a user interface.

68. The computer program product according to claim 63, wherein when a cursor is located in said editable area, pressing a key moves said cursor to a next editable area.

69. The computer program product according to claim 63, wherein said key is a right arrow key.

70. The computer program product according to claim 63, wherein if no information is provided in said editable field, said tag is automatically created.
